(19) United States
(12) Patent Application Publication
(10) Pub. No.: US 2023/0322572 A1
(43) Pub. Date: Oct. 12, 2023

(54) FABRICATION OF POROUS ALUMINUM AND ITS TRANSFORMATION TO ALUMINUM-BASED NANOWIRES AND AEROGELS

(71) Applicants: Sila Nanotechnologies, Inc., Alameda, CA (US); Georgia Tech Research Corporation, Atlanta, GA (US)

(72) Inventors: Gleb YUSHIN, Atlanta, GA (US); Fujia WANG, Atlanta, GA (US); Samik JHULKI, Emeryville, CA (US); Kostiantyn TURCHENIUK, Oakland, CA (US)

(21) Appl. No.: 18/298,606

(22) Filed: Apr. 11, 2023

Related U.S. Application Data
(60) Provisional application No. 63/362,811, filed on Apr. 11, 2022.

(51) Int. Cl. C01F 7/30; H01M 10/058; H01M 10/0525; H01M 50/434; H01M 50/403

(52) U.S. Cl. CPC C01F 7/30; H01M 10/058; H01M 10/0525; H01M 50/434; H01M 50/403; C01P 2004/16

(57) ABSTRACT

A method of making aluminum alkoxide nanowires is disclosed. In some embodiments, the method includes: (1) treating an alloy comprising aluminum (Al) and lithium (Li) with a reactive solvent to form a porous metal comprising Al; and (2) treating the porous metal with an alcohol-comprising solvent to form the Al alkoxide nanowires. In some embodiments, the reactive solvent has a pKₐ value at 25° C. that is less than 15. In some implementations, water is employed as the reactive solvent and ethanol is employed as the alcohol-comprising solvent. Methods of making Al oxide nanowires, Al hydroxide nanowires, an aerogel, and a lithium-ion battery are also disclosed.

### CROSS-REFERENCE TO RELATED APPLICATIONS

The present Application for Patent claims the benefit of U.S. Provisional Application No. 63/362,811, entitled “FABRICATION OF POROUS ALUMINUM AND ITS TRANSFORMATION TO ALUMINA NANOWIRE AEROGELS FOR POLYMER MATRIX COMPOSITES,” filed Apr. 11, 2022, assigned to the assignee hereof, and expressly incorporated herein by reference in its entirety.

### BACKGROUND

### Field

Aspects of the present disclosure relate generally to fabrication of porous aluminum and its transformation to alumina nanowire aerogels (e.g., for polymer matrix composites).

### Background

High mechanical strength of one-dimensional (1D) ceramic nanofibers (often called nanowires (NWs)) allow fabrication of lightweight, high load-bearing and thermally stable composite materials. The reduced size, high surface-to-volume and high aspect ratios enable ceramic NWs to attain magnetic, thermal, optical and electrical, and mechanical properties strikingly different (and often significantly superior for applications) than their conventional micro- and macroscopic counterparts, including micron-scale fibers. These features make ceramic NWs highly attractive for use in electronics, photovoltaics, advanced sensing, electrochemical, and electromechanical devices. In particular, alumina (Al₂O₃) NWs are lightweight (density ˜3.7 g/cc for nonporous NWs) and strong (reported high shear modulus of ˜124 GPa, Young's modulus of 210-300 GPa, and maximum tensile strength of up to ˜12 GPa), possess a wide band gap (5.1-8.8 eV) and a moderate dielectric constant (ca. 9.8), and exhibit a high thermal stability (up to ˜1200° C.) and a modest thermal conductivity (ca. 18 W m⁻¹K), which are attractive properties for use in microelectronics, aerospace industry, filtration, adsorption, catalysis, thermal insulation, and other important applications. However, conventional synthesis of Al₂O₃ and other ceramic NWs by chemical vapor deposition (CVD), electrodeposition, and other means is rather elaborate, expensive, and difficult to scale. Herein, the term “.ca” means “about”.

The breakthrough discovery of the formation of metal-organic NWs directly from 3-dimensional (3D) bulk bimetallic alloys upon their reaction with alcohols at ambient temperatures and pressure opened novel low-cost manufacturing pathways for the synthesis of a broad range of functional ceramic and metallic (nano)materials and (nano)composites. This method was previously utilized for a facile transformation of polycrystalline aluminum-lithium (Al—Li) alloy particles to Al ethoxide NWs, and was further extended to the synthesis of porous copper (Cu) and copper oxide (CuO) NWs from copper-calcium (Cu—Ca) alloys, Mg propoxide NWs from magnesium-lithium (Mg—Li) alloys, and zinc (Zn) NWs from zinc-lithium (Zn—Li) alloys.

In the case of Al alkoxide NWs, upon the dissolution of Li component of the Al—Li alloy in anhydrous alcohol, highly reactive Al forms and then transforms into polymeric Al ethoxide. Owing to the accompanied interfacial stresses and the strain energy minimization at the boundary of the metal-to-ethoxide transformation front, the formation of 1D structure of alkoxides becomes thermodynamically and kinetically favorable. The oxide groups serving as good bridging ligands enable the formation of polymeric Al ethoxide NWs. Thus formed Al ethoxide NWs are often present in the form of the insoluble suspension of bundles, which typically need to be separated from the Li-ethoxide/ethanol solution, dried in an inert environment, and further split into individual NWs by bathing in a fresh hot ethanol solution over a period of several hours. After splitting, individualized and dried Al ethoxide NWs can be transformed to a pure alumina ceramic NWs by heating in air. Unfortunately, the separation of Li ethoxides from the anhydrous alcohol suspension of NWs bundles and further purification and splitting of NWs after the de-alloying process under inert atmosphere are associated with undesired loss of NWs. In addition to physical losses of small individual NWs during several filtration steps, some Al is believed to be dissolved in the form of semi-soluble mixed Al—Li ethoxides, typically reducing attainable yields to ˜85% or below.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

The fabrication of alumina (Al₂O₃) aerogels offers great opportunities for the manufacturing of polymer matrix composites with unique, otherwise unattainable properties, but suffers from high cost and complex synthesis steps. Here, the inventors report on a simple method to produce Al₂O₃ nanowires (NW)-based aerogels. The synthesis of Al hydroxide (Al(OH)₃) NWs was built up from our previously reported revolutionary NW fabrication approach but with a significant leap forward that enabled a higher yield, shorter processing time and reduced synthesis and material handling costs. In particular, the inventors report on the formation of monolithic porous Li-doped Al particles by ambient temperature de-alloying in water. The inventors demonstrate such bulk particles to transform to Al ethoxide NWs in a reaction with ethanol. Upon hydrolysis of the as-synthesized Al ethoxide NWs, the formation of Al(OH)₃ is revealed, which could be further transformed into Al₂O₃ NWs with full retention of NW morphology. The reported ability to produce and handle such materials in open air provides significant benefits to industrial large-scale synthesis, storage and transportation. The reported ultra-low-cost Al(OH)₃ NW synthesis allowed us to fabricate Al₂O₃ NW aerogels for promising polymer composite applications.

In an aspect, a method of making aluminum alkoxide nanowires includes treating an alloy comprising aluminum (Al) and lithium (Li) with a reactive solvent to form a porous metal comprising Al; and treating the porous metal with an alcohol-comprising solvent to form the Al alkoxide nanowires, wherein: the reactive solvent has a pKa value at 25° C. that is less than 15.

In some aspects, the pKa value at 25° C. is about 14.

In some aspects, the reactive solvent comprises water.

In some aspects, the alcohol-comprising solvent comprises ethanol; and the Al alkoxide nanowires comprises Al ethoxide nanowires.

In some aspects, the alloy comprises Li at a mass fraction in the alloy in a range of about 0.1 wt. % to about 10 wt. %.

In some aspects, the method includes annealing the Al alkoxide nanowires to form Al oxide nanowires.

In some aspects, the method includes hydrolyzing the Al alkoxide nanowires in a hydrolyzing environment to form Al hydroxide nanowires.

In some aspects, the hydrolyzing environment comprises ambient air.

In some aspects, the method includes annealing the Al hydroxide nanowires to form Al oxide nanowires.

In some aspects, the method includes dispersing the Al hydroxide nanowires in an aqueous solvent to form a nanowire dispersion.

In some aspects, the aqueous solvent is water.

In some aspects, the method includes freeze-drying the nanowire dispersion to form an aerogel, wherein: the aerogel comprises the Al hydroxide nanowires and/or Al oxide nanowires.

In some aspects, the method includes annealing the aerogel.

In some aspects, the method includes filling the aerogel with a matrix material, the matrix material being selected from polymers, metals, and glasses.

In some aspects, the method includes coating the nanowire dispersion on at least one of an anode and a cathode to form at least one separator layer; assembling a lithium-ion battery cell from the anode and the cathode with the at least one separator layer positioned between the anode and the cathode; and filling an electrolyte ionically coupling the anode and the cathode in the lithium-ion battery cell to form a lithium-ion battery.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and other techniques described herein may be implemented.

FIG. 2 shows a Table 1 listing several common solvents and their pKₐ values.

FIG. 3A is a schematic representation of a process of forming porous Al.

FIGS. 3B, 3C, and 3D are scanning electron microscope (SEM) images of an Al—Li alloy (with Li mass fraction in the alloy of about 4 wt. %, referred to as Al—Li4 alloy herein), Al—Li4 alloy after treatment in deionized water for about 10-20 seconds, and porous Al after the Al—Li4 alloy has been treated in deionized water for about 24 h, respectively.

FIG. 3E shows the x-ray diffraction (XRD) data measured on the porous Al sample and the Rietveld refinement thereof.

FIG. 3F shows the x-ray photoelectron spectroscopy (XPS) data for the Al2p orbitals measured on pure Al, Al—Li4 alloy, and porous Al samples.

FIG. 4A is a schematic representation of a process of forming Al ethoxide nanowires.

FIGS. 4B, 4C, and 4D are SEM images of an Al ethoxide forest formed after the first 5 minutes of a reaction between porous Al and ethanol, Al ethoxide nanowires after about one hour of growth in ethanol, and Al ethoxide nanowires after growth in ethanol for about 96 h, respectively.

FIG. 5A shows spectra as measured by Fourier-transform infrared spectroscopy (FT-IR) on commercially available Al ethoxide powder, as-synthesized Al ethoxide nanowires synthesized according to some embodiments (referred to as WE-NWs), and as-synthesized Al ethoxide nanowires synthesized according to an alternative process (referred to as E-NWs), respectively. As described in detail herein, the example WE-NW-type Al ethoxide nanowires are formed by reacting an Al—Li4 alloy with water (e.g., deionized (DI) water, tap water, etc.)to form porous Al, and then reacting the porous Al with ethanol to form Al ethoxide nanowires. As described in detail herein, the example E-NW-type Al ethoxide nanowires are formed by reacting an Al—Li4 alloy with ethanol to form bundles of Al ethoxide nanowires, and then reacting the bundles of Al ethoxide nanowires with ethanol to form individual Al ethoxide nanowires.

FIG. 5B shows FTIR spectra as measured on commercially available Al ethoxide powder, WE-NW-type Al ethoxide nanowires, and E-NW-type Al ethoxide nanowires, respectively, after exposure to ambient air for 24 h.

FIG. 5C shows ²⁷Al magic-angle spinning (MAS) solid-state nuclear magnetic resonance (NMR) spectroscopy data for Al ethoxide nanowires (WE-NW-type) before and after hydrolysis (exposure to ambient air), respectively.

FIG. 5D shows ¹³C cross-polarization (CP) MAS solid-state NMR spectroscopy data for Al ethoxide nanowires (WE-NW-type) before and after hydrolysis (exposure to ambient air), respectively.

FIG. 5E is a schematic representation, at a molecular level, of a hydrolysis process that converts Al alkoxide nanowires to Al hydroxide nanowires, as implemented in some embodiments.

FIG. 6A is a schematic representation of a process of forming an aerogel from a nanowire dispersion.

FIG. 6B is a photograph of an example aerogel formed according to the process outlined in FIG. 6A and as described in detail herein.

FIG. 7 is a flow diagram of a process of making Al alkoxide nanowires according to some embodiments.

FIG. 8 is a flow diagram of a process of making Al oxide nanowires according to some embodiments.

FIG. 9 is a flow diagram of a process of making Al hydroxide nanowires according to some embodiments.

FIG. 10 is a flow diagram of a process of making Al oxide nanowires according to some embodiments.

FIG. 11 is a flow diagram of a process of making a dispersion of Al hydroxide nanowires according to some embodiments.

FIG. 12 is a flow diagram of a process of making an aerogel according to some embodiments.

FIG. 13 is a flow diagram of a process of making a lithium-ion battery according to some embodiments in which a nanowire dispersion is coated on at least one of the anode and the cathode.

FIG. 14 is a flow diagram of a process of making a lithium-ion battery according to some embodiments in which a nanowire dispersion is employed to form a separator membrane.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about—120° C. to about—60° C. encompasses (in ° C.) a set of temperature ranges from about—120° C. to about—119° C., from about—119° C. to about—118° C., . . . from about—61° C. to about—60° C., as if the intervening numbers (in ° C.) between—120° C. and—60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “.ca” or “˜” 80%, which encompasses “exactly” 80% (e.g., 80.0000 . . . %) plus some range around 80%. In some designs, the range encompassed around a measurement or threshold via the “about”, “approximately”, “around”, “.ca” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | Property | Measurement | Measurement |
|---|---|---|---|
| Type | Type | Instrumentation | Technique |
| Active | Coulombic | Potentiostat | Charge (current) is passed to an |
| Material | Efficiency | | electrode containing the active |
| | | | material of interest until a given |
| | | | voltage limit is reached. Then, |
| | | | the current is reversed until a |
| | | | second voltage limit is reached. |
| | | | The ratio of the charge passed |
| | | | determines the coulombic |
| | | | efficiency. |
| Active | Partial Vapor | Manometer | The partial vapor pressure of an |
| Material | Pressure (e.g., | | active material in a mixture |
| | Torr.) at a | | (e.g., composite particle) at a |
| | Temperature | | particular temperature is given |
| | (e.g., K) | | by the known vapor pressure of |
| | | | the active material multiplied by |
| | | | its mole fraction in the mixture. |
| Active | Volume | Gas pycnometer | Gas pycnometer measures the |
| Material | | | skeletal volume of a material by |
| Particle | | | gas displacement using the |
| | | | volume-pressure relationship of |
| | | | Boyle's Law. A sample of |
| | | | known mass is placed into the |
| | | | sample chamber and maintained |
| | | | at a constant temperature. An |
| | | | inert gas, typically helium, is |
| | | | used as the displacement |
| | | | medium. |
| | | | Note: A vol. % change may be |
| | | | calculated from two volume |
| | | | measurements of the active |
| | | | material particle. |
| Active | Open Internal | nitrogen | nitrogen sorption/desorption |
| Material | Pore Volume | sorption/desorption | isotherm technique |
| Particle | (e.g., cc/g or | isotherm | |
| | cm³/g) | | |
| Active | Volume- | PSA, scanning | PSA using laser scattering, |
| Material | Average Pore | electron microscope | electron microscopy (SEM, |
| Particle | Size (e.g., | (SEM), transmission | TEM, STEM), laser microscopy |
| | nm) | electron microscope | (for larger particles), optical |
| | | (TEM), scanning | microscopy (for larger |
| | | transmission | particles), neutron scattering, X- |
| | | microscope | ray microscopy imaging |
| | | (STEM), laser | |
| | | microscope, | |
| | | Synchrotron X-ray, | |
| | | X-ray microscope | |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing to the theoretical |
| | | | density of the individual |
| | | | material components present in |
| | | | Si-comprising particles |
| Active | Closed | Gas pycnometer | With a pycnometer, the amount |
| Material | Internal | | of a certain medium (liquid or |
| Particle | Volume- | | Helium or other analytical |
| | Average Size | | gases) displaced by a solid can |
| | (e.g., nm) | | be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), X- |
| | | | ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in |
| | %, mg, | | the particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known theoretical capacit(ies) |
| | | | of each active material. |
| | | | Note #3: The composition of the |
| | | | particle may be characterized in |
| | | | terms of weight (e.g., mg). The |
| | | | composition of may |
| | | | alternatively be characterized by |
| | | | a number of atoms of a |
| | | | particular element (e.g., Si, C, |
| | | | etc.). In case of atoms, the |
| | | | number of atoms may be |
| | | | estimated from the weight of |
| | | | that atom in the particle (e.g., |
| | | | based on gas chromatography) |
| Active | Specific | Potentiostat | An electrode containing an |
| Material | Capacity | | active anode or cathode material |
| Particle, | | | of interest is charged or |
| Battery Half- | | | discharged (by passing |
| Cell | | | electrical current to the |
| | | | electrode) within certain |
| | | | potential limits using an |
| | | | electrochemical cell with |
| | | | suitable reference electrode, |
| | | | typically lithium metal. The |
| | | | total charge passed divided by |
| | | | the active material mass gives |
| | | | this quantity. The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a sealed |
| Material | (e.g., m²/g) | | chamber, where nitrogen is |
| Particle | | | introduced. The change in |
| | | | pressure of the nitrogen is used |
| | | | to calculate the surface area of |
| | | | the sample. |
| Active | Aspect Ratio | SEM, TEM | The dimensions and shape of |
| Material | | | the particles are measured in |
| Particle | | | SEM or TEM. |
| Active | True Density | Argon Gas | True density values may be |
| Material | of Particle | Pycnometer | measured by using an argon gas |
| Particle | (e.g., g/cc or | | pycnometer and comparing to |
| | g/cm³) | | the theoretical density of the |
| | | | individual material components |
| | | | present in the particle. |
| Active | Particle Size | Dynamic light | laser particle size distribution |
| Material | Distribution | scattering particle | analysis (LPSA) on well- |
| Particle | (e.g., nm or | size analyzer, | dispersed particle suspensions |
| Population | μm) | scanning electron | in one example or by image |
| | | microscope | analysis of electron microscopy |
| | | | images, or by other suitable |
| | | | techniques. While there are |
| | | | diverse processes of measuring |
| | | | PSDs, laser particle size |
| | | | distribution analysis (LPSA) is |
| | | | quite efficient for some |
| | | | applications. Note that other |
| | | | types of particle size |
| | | | distribution (e.g., by SEM |
| | | | image analysis) could also be |
| | | | utilized (and may even lead to |
| | | | more precise measurements, in |
| | | | some experiments). Using |
| | | | LPSA, particle size parameters |
| | | | of a population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a ninetieth- |
| | | | percentile volume-weighted |
| | | | particle size parameter (e.g., |
| | | | abbreviated as D₉₀), and a |
| | | | ninety-ninth-percentile volume- |
| | | | weighted particle size parameter |
| | | | (e.g., abbreviated as D₉₉). |
| Active | Width (e.g., | PSA | Parameters relating to |
| Material | nm) | | characteristic widths of the PSD |
| Particle | | | may be derived from these |
| Population | | | particle size parameters, such as |
| | | | D₅₀-D₁₀ (sometimes referred |
| | | | to herein as a left width), |
| | | | D₉₀-D₅₀ (sometimes referred to |
| | | | herein as a right width), and |
| | | | D₉₀-D₁₀ (sometimes referred to |
| | | | herein as a full width). |
| Active | Cumulative | Computed via LPSA | A cumulative volume fraction, |
| Material | Volume | data | defined as a cumulative volume |
| Particle | Fraction | | of the composite particles with |
| Population | | | particle sizes of a threshold |
| | | | particle size or less, divided by |
| | | | a total volume of all of the |
| | | | composite particles, may be |
| | | | estimated by LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m2/g) | | nitrogen sorption-desorption at |
| Particle | | | cryogenic temperatures, such as |
| Population | | | about 77K |
| Electrolyte | Salt | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar mass of the |
| | | | salt is then used to calculate the |
| | | | total number of moles of salt in |
| | | | the solution. The moles of salt is |
| | | | then divided by the total volume |
| | | | to obtain the solvent |
| | | | concentration in M (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar volume of |
| | | | each solvent is then used to |
| | | | calculate the total number of |
| | | | moles of solvent in the solution. |
| | | | The moles of solvent is then |
| | | | divided by the total volume to |
| | | | obtain the solvent concentration |
| | | | in M (mol/L). |
| Electrode | Composition | Balance | The mass fraction of a material |
| | (e.g., mass | | (e.g., active material, active |
| | fraction | | material particle, binder, etc.) in |
| | or wt. %) | | the electrode is calculated based |
| | | | on a measured or estimated |
| | | | mass of the material and a |
| | | | measured or estimated mass of |
| | | | the electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of the |
| | | | battery electrode composition |
| | | | may be measured before being |
| | | | mixed into a slurry to estimate |
| | | | their mass in a casted electrode. |
| | | | The mass of materials deposited |
| | | | onto the casted electrode may |
| | | | be measured by comparing the |
| | | | weight of the casted electrode |
| | | | before/after the material |
| | | | deposition. |
| Electrode | Areal Binder | balance | A mass fraction of the binder in |
| | Loading (e.g., | | the battery electrode, divided by |
| | mg/m²) | | a product of (1) a mass fraction |
| | | | of the active material (e.g., Si—C |
| | | | nanocomposite, etc.) particles in |
| | | | the battery electrode, and (2) a |
| | | | Brunauer-Emmett-Teller (BET) |
| | | | specific surface area of the |
| | | | population |
| Electrode | Capacity | Calculated | Measure mass (wt.) of active |
| | Attributable | | material in electrode, and |
| | to Active | | calculate electrode capacity |
| | Material | | based on known theoretical |
| | (active | | capacity of the active material. |
| | material | | For example, the average wt. % |
| | capacity | | of active material in each active |
| | fraction) | | material particle may be |
| | | | measured, and used to calculate |
| | | | the mass of the active material |
| | | | based on the mass of the active |
| | | | material particles before being |
| | | | mixed in slurry. This process |
| | | | may be repeated if the electrode |
| | | | includes two or more active |
| | | | materials to calculate the |
| | | | relative capacity attribution for |
| | | | each active material in the |
| | | | electrode. |
| Electrode | Capacity | Potentiostat and | Determine average specific |
| | Attributable | balance | capacity (g/mAh) of active |
| | to Active | | material particles. For example, |
| | Material | | the average specific capacity |
| | Particles | | may be estimated from the |
| | (active | | average wt. % of active |
| | material | | material(s) in each particle and |
| | particle | | its associated known theoretical |
| | capacity | | capacit(ies). Then, measure |
| | fraction) | | mass (wt.) of active material |
| | | | particles in electrode before |
| | | | being mixed in slurry, which |
| | | | may be used to calculate the |
| | | | capacity attributable to that |
| | | | active material. This process |
| | | | may be repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active material |
| | Material in | | particle may be measured, and |
| | Electrode | | used to calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in slurry. |
| | Electrode | | |
| Electrode | Areal | Potentiostat and | Areal capacity loading is weight |
| | Capacity | balance | of the coated active material per |
| | Loading (e.g., | | unit area (g/cm²) multiplied by |
| | mAh/cm²) | | the gravimetric capacity of the |
| | | | active material (not the |
| | | | electrode, but the active |
| | | | material itself with zero binder |
| | | | and zero electrolyte; mAh/g). |
| Electrode | Coulombic | Potentiostat | The change in charge inserted |
| | Efficiency | | (or extracted) to an electrode |
| | | | divided by the charge extracted |
| | | | (or inserted) from the electrode |
| | | | during a complete |
| | | | electrochemical cycle within |
| | | | given voltage limits. Because the |
| | | | direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half- |
| | | | cell, which is an electrochemical |
| | | | cell consisting of a cathode or |
| | | | anode material of interest as the |
| | | | working electrode and a lithium |
| | | | metal foil which functions as |
| | | | both the counter and reference |
| | | | electrode. Then, charge is either |
| | | | inserted or removed from the |
| | | | material of interest until the cell |
| | | | voltage reaches an appropriate |
| | | | limit. Then, the process is |
| | | | reversed until a second voltage |
| | | | limit is reached, and the charge |
| | | | passed in both steps is used to |
| | | | calculate |
| | | | the Coulombic |
| | | | Efficiency, as described above. |
| Battery Cell | Rate | Potentiostat | This is the time it takes to |
| | Performance | | charge or discharge a battery |
| | | | between a given state of charge. |
| | | | It is measured by charging or |
| | | | discharging a battery and |
| | | | measuring the time until a |
| | | | specified amount of charge is |
| | | | passed, or until the battery |
| | | | operating voltage reaches a |
| | | | specified value. |
| Battery Cell | Cell | Potentiostat | A battery consisting of a |
| | Discharge | | relevant anode and cathode is |
| | Voltage (e.g., | | charged and discharged within |
| | V) | | certain voltage limits and the |
| | | | charge-weighted cell voltage |
| | | | during discharge is computed. |
| Battery Cell | Operating | Potentiostat and | Average temperature of battery |
| | Temperature | thermocouples | cell as measured at the |
| | | | positive/negative terminal/cell |
| | | | shaft/etc. while |
| | | | charging/discharging, or at a |
| | | | certain voltage level, or while a |
| | | | load is applied, etc. |
| Battery Half- | Anode | Potentiostat | An electrode containing an |
| Cell | Discharge | | active anode material (or |
| | (de-lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or |
| | (lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | the VED is calculated by first |
| | Energy | | calculating the energy per unit |
| | Density | | area of the battery, and then |
| | (VED) | | dividing the energy per unit area |
| | | | by the sum of the illustrative |
| | | | anode, cathode, separator, and |
| | | | current collector thicknesses |
| Battery Cell | Internal | Potentiostat | The internal resistance (also |
| | Resistance | | known as impedance in many |
| | (impedance) | | contexts) is measured by |
| | | | applying small pulses of current |
| | | | to the battery cell and recording |
| | | | the instantaneous change in cell |
| | | | voltage. |

In some embodiments described below, certain parameters (e.g., temperature, state-of-charge (SOC), etc.) may be defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

Further, while the description below may also describe certain examples of metal or metal alloy particles, polymer particles or polymer-derived particles, porous particles or composite particles having spherical or spheroidal three dimensional (3D) shape, it will be appreciated that various aspects may be applicable to particles having other shapes, including, for example, irregular shapes, elongated two-dimensional (2D, such as (nano)composite platelets or porous sheets, etc.) shapes or one dimensional (1D, such as, for example, wires, nanowires, (nano)composite nanofibers and fibers or porous nanofibers and fibers, etc.) shapes.

While the description below may describe certain embodiments in the context of improved battery electrodes or improved battery cells, it will be appreciated that improved battery modules or packs may be enabled with different aspects of the disclosed technologies. Such modules or packs, for example, may be smaller, lighter, safer, simpler, less expensive, provide more energy, provide higher power, provide longer cycle life, provide longer calendar life, provide better operation at low temperatures, provide better operation at high temperatures and other important features. It will similarly be appreciated that improved electronic devices, improved electric scooters, electric bicycles, electric cars, electric trucks, electric buses, electric ships, electric planes and, more broadly, improved electric and hybrid electric ground, sea, and aerial (flying) vehicles (including heavy vehicles, autonomous vehicles, unmanned vehicles, planes, space vehicles, satellites, submarines, etc.), improved robots, improved stationary home or stationary utility energy storage units and improved other end products may be enabled with different aspects of the disclosed technologies. Such devices may be smaller, lighter, offer longer range, faster charging, faster acceleration, better operation at different temperatures, lower cost, longer calendar life, slower degradation with repeated charging and discharging, better safety, etc.

While the description below may also describe certain examples of the material formulations in a Li-free state (for example, as in silicon-comprising nanocomposite anodes or metal fluoride cathodes), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride or metal oxyfluoride comprising cathodes (such as a mixture of LiF or Li₃OF and metals or partially oxidized metals, such as Cu, Fe, Ni, Bi, Zr, Zn, Nb, W, Mo, Mn, Ti and various other metals, metal alloys comprising such and other metals, metal oxides and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li2Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state.

While the description of one or more embodiments below may describe certain examples in the context of aluminum-(Al—) or oxygen-(O—) comprising nanowires (NW) (which may also be called whiskers or nanofibers or other elongated particles and may be porous elongated particles in some embodiments), it will be appreciated that various aspects may be applicable to other compositions (such as other single metal or mixed metal oxides as well as single metal (or mixed metal(s)) oxyfluorides, single metal (or mixed metal(s)) fluorides, single metal (or mixed metal(s)) oxynitrides, single metal (or mixed metal(s)) nitrides, single metal (or mixed metal(s)) oxyhydroxides, single metal (or mixed metal(s)) sulfides or selenides, single metal (or mixed metal(s)) carbides, single metal (or mixed metal(s)) oxycarbides, single metal (or mixed metal(s)) carbonitrides, single metal (or mixed metal(s)) oxycarbonitrides, single metal (or mixed metal(s)) oxyhydroxides, single metal (or mixed metal(s)) hydroxides and various other (e.g., ceramic) elongated particles that comprise single metal or mixed metal(s) compositions). Examples of suitable metal (or semimetal) atoms for such compositions may include (but not limited to) at least one of the following (depending on the particular application) or their combination: Al, Li, Mg, Ti, Ta, Li, Sc, Cu, Fe, Na, K, Cs, Ba, Be, C, Zn, Cr, Zr, Y, La, Ce, Sn, Sb, Si, Sm, Mo, Nb, Ta, W, Ag, Au, Pt, U, to name a few. In some designs, such metals may not form carbides or other ceramic compounds, as known in state of the art.

While the description of one or more embodiments below may describe certain examples in the context of nanowires (or whiskers, nanofibers, nanoribbons or other elongated particles with aspect ratio in the range from around 5 to around 100,000,000, more commonly in the range from around 20 to around 50,000) that comprise a single metal (for example, just Al or just Mg) in their composition, it will be appreciated that various aspects may be applicable to compositions that comprise two, three or more metals. For example, Al may be used in combination with Li, Mg, Si, Cu, Zn, Zr, Ti, Ta, Cr, La (or Ln in general), Y, Sc, and many other metals to form oxide, oxyfluorides, fluorides, oxynitrides, nitrides, oxyhydroxides, sulfides, selenides and various other ceramic compositions of interest. Similarly, Mg and other metals may be used in combination with Li, Al, Si, Zn, Zr, Ti, Ta, Cr, La (or Ln in general), Y, Sc, and many other metals to form oxide, oxyfluorides, fluorides, oxynitrides, nitrides, oxyhydroxides, sulfides, selenides and various other ceramic compositions of interest.

While the description of one or more embodiments below may describe certain examples in the context of formation of metal alkoxide NWs in the form of metal ethoxide NWs, it will be appreciated that various aspects may be applicable to the formation of other types of alkoxide nanowires (e.g., various metal propoxide NWs, metal methoxide NWs, etc.).

While the description of one or more embodiments below may describe certain examples in the context of formation of metal-organic NWs in the form of metal alkoxide NWs, it will be appreciated that various aspects may be applicable to the formation of other types of metal-organic NWs.

While the description of one or more embodiments below may describe certain examples in the context of pure metal alkoxide NWs, it will be appreciated that various aspects may be applicable to compositions that may contain alkoxide and some fraction of alkoxide adjacent species, such as hydroxide, oxyhydroxide, oxide, nitride, oxynitride, fluoride, oxyfluoride or many others. In some designs, the structure of pure alkoxide may contain bridging alkoxide groups (where oxygen of alkoxide is bonded to two or more metal atoms) and terminal alkoxide groups (where oxygen of alkoxide is bonded to one metal atom). Note that in the compositions that may contain both alkoxide and one or more other species (such as hydroxy-alkoxides, carboxy-alkoxide, oxy-alkoxide, nitrido-alkoxides, among many others), either the alkoxide or the other group(s) may occupy bridging or terminal positions. As such, the coordination number for metal atoms in such compositions may vary from that of the pure alkoxides and the ratio of the alkoxide groups (—RO) to metal atoms may vary from that of the pure alkoxides. For example, in case of aluminum ethoxide compositions, the aluminum (Al) atoms may not be 6-coordinated (as expected for pure Al(EtO)₃), but may, for example, comprise 6-coordinated, 5-coordinated, 4-coordinated and 3-coordinated Al atoms. Similarly, the molar ratio of ethoxide groups (—EtO) to Al atom may not be 3 (as expected for pure Al(EtO)3), but may, for example, range from as high as around 10 to as low as around 0.1. Similarly, Al ethoxide can comprise ethoxy, hydroxy, oxy, ether, and ethanol ligands, such as Al(EtO)_{3-(x+y+z+w)}(OH)ₓ(EtOH)_{y}(O)_{z(Et2O)w}, where x, y, z, and w range from as high as 3 to as low as 0 (e.g., in some designs, as low as ˜0.001), and where (x+y+z+w) should not exceed 3. Similarly, ethoxy, hydroxy, oxy and ethanol ligands can occupy bridging or terminal positions.

While the description of one or more embodiments below may describe certain examples in the context of monomeric alkoxides, it will be appreciated that various aspects may be applicable to compositions that may contain oligomeric and polymeric alkoxides than may contain from about 2 to about 1,000,000,000 repeat units. Examples of such alkoxides may include aluminum ethoxide compositions such as [Al(EtO)_{3-(x+y+z+w)}(OH)ₓ,(EtOH)_{y}(O)_{z(Et2O)w}]ₙ, where x, y z, and w may range from as high as 3 to as low as 0 (e.g., in some designs, ˜0.001) and n may range from about 1 to about 1,000,000,000. Similarly, monomer units in oligomers and polymers may comprise chemically different units, where ligand positions may be different. Similarly, monomer units in oligomers and polymers may comprise 6-coordinated, 5-coordinated, 4-coordinated and 3-coordinated Al atoms. Similarly, oligomeric and polymeric alkoxides may each exhibit a different tacticity, molecular weight and/or polydispersity index. Tacticity in this context refers to the spatial orientation of the functional groups attached to the Al center present in a one-dimensional chain. They could be oriented in the same spatial direction in all consecutive Al centers (isotactic) or they could be oriented in opposite directions in consecutive Al centers (syndiotactic) or they could be oriented in no particular order (atactic). Each polymeric chain may also have a mixture of isotactic, syndiotactic and atactic regions. The polydispersity index of the polymeric chain, which is a ratio of weight average molecular weight and number average molecular weight, could be in the range of 1-20.

While the description of one or more embodiments below may describe certain examples in the context of converting metal-organic (e.g., alkoxide, such as ethoxide, n-propoxide, iso-propoxide and others) NWs to oxide NWs by heating in air (or, more generally, in oxygen-containing gas or water vapor-containing gas or in some designs, inert gas or in some designs, oxygen-containing or water-containing solution or their various combinations), it will be appreciated that various aspects may be applicable to the formation of ceramic NWs by treatment of the metal-organic NWs in other controlled environments (e.g., in water-comprising solution or water-comprising vapors or gas, in ammonia or ammonia-comprising solution or gas comprising ammonia vapors or nitrogen plasma for the formation of nitrides or oxynitrides or, more generally, nitrogen-doped or nitrogen-containing ceramics; methane, ethylene, acetylene, propylene or other hydrocarbon-containing gases or their mixtures for the formation of carbides or oxycarbides or carbo-nitrides or carbon-doped or more generally carbon-containing ceramics; gases comprising sulfur vapors or hydrogen sulfide or more generally sulfur-containing gases/plasma for the formation of sulfides or oxysulfides or sulfur-doped or, more generally, sulfur-containing ceramics, gases comprising fluorine atoms or fluorine ions for the formation of fluorides or oxyfluorides or fluoronitrides or oxyfluoronitrides or more generally fluorine containing ceramics, hydrogen or forming gas, such as hydrogen and argon mixture, or a hydrogen mixture with other gases; etc.).

While the description of one or more embodiments below may describe certain examples in the context of converting metal-organic (e.g., alkoxide, such as ethoxide and others) NWs to ceramic (e.g., oxide) NWs by heating at atmospheric pressure, it will be appreciated that such heat-treatments could be conducted in vacuum (sub-atmospheric pressure) or above atmospheric pressure (e.g., in solvothermal reactors or in high pressure gaseous reactors) in some designs.

While the description of one or more embodiments below may describe certain examples in the context of converting metal-organic (e.g., alkoxide, such as ethoxide or propoxide and others) NWs to ceramic (e.g., oxide) NWs in a single stage (heating/cooling at the same pressure in the same environment/composition), in some designs it may be advantageous to utilize multiple stages, where each stage differs from others in terms of environment (e.g., oxygen or moisture content or different composition of other reactive gas species), pressure, temperature, phase and/or other factors.

While the description of one or more embodiments below may describe certain examples in the context of converting metal-organic (e.g., alkoxide, such as ethoxide or propoxide and others) NWs to ceramic (e.g., oxide) NWs by heating in a gaseous environment, it will be appreciated that at least one step in such a conversion process may be conducted in a liquid phase.

While the description of one or more embodiments below may describe certain examples in the context of converting metal-organic (e.g., alkoxide, such as ethoxide or propoxide and others) NWs to ceramic (e.g., oxide) NWs in an environment comprising a non-ionized gas, it will be appreciated that at least one stage in such a conversion process may be conducted in an environment comprising an ionized gas (e.g., treatment in plasma).

While the description of one or more embodiments below may describe certain examples of alcohol reagents (e.g., ethanol, methanol, iso-propanol, n-propanol, tert-butanol, and others) to convert porous metal to metal-organic NWs, it will be appreciated that various aspects may be applicable to alcohols of the general formula ROH in which R can be hydrogen (H), NH₂, OH, alkyl, C1-6 alkyl, hydroxy-C1-6 alkyl, amino-C1-6 alkyl, carboxy-C1-6 alkyl, C3-6 cycloalkyl, C2-6 alkenyl, C2-6 alkynyl, aryl, phenyl (C₆H₅), naphthyl, heteroaryl, C1-6 alkyl-phenyl, cyclohexyl, RC₆H₄- (where R is C1-6 alkyl, hydroxyalkyl, aminoalkyl, carboxyalkyl, aryl, phenyl (C₆H₅), naphthyl, heteroaryl, alkylphenyl, OH, NH₂, SO₃H), polycyclic aryl, among others.

While the description of one or more embodiments below may describe certain examples of alcohol reagents of a general formula ROH to convert porous metal to metal-organic NWs, it will be appreciated that various aspects may be applicable to other reagents of a general formula RNH₂ in which R can be hydrogen (H), NH₂, OH, C1-6 alkyl, hydroxy-C1-6 alkyl, amino-C1-6 alkyl, carboxy-C1-6 alkyl, C3-6 cycloalkyl, C2-6 alkenyl, C2-6 alkynyl, aryl, phenyl (C₆H₅), naphthyl, heteroaryl, alkylphenyl, cyclohexyl, RC₆H₄—(where R is C1-6 alkyl, hydroxy-C1-6 alkyl, amino-C1-6 alkyl, carboxy-C1-6 alkyl, aryl, phenyl (C₆H₅), naphthyl, heteroaryl, alkylphenyl, OH, NH₂, SO₃H), polycyclic aryl, among others. In other designs, it will be appreciated if RNH₂ reagents may be used in solutions of water, alcohols or aqueous solutions of bases.

While the description of one or more embodiments below may describe certain examples of alcohol reagents (e.g., ethanol, methanol, iso-propanol, n-propanol or others) to convert bulk alloys to metal-organic NWs, it will be appreciated that various aspects may be applicable to solutions comprising acids, bases or metal salts in alcohols.

While the description of one or more embodiments below may describe certain examples of pure NW (nanofiber) comprising compositions, it will be appreciated that various aspects may be applicable to compositions comprising a mixture of NWs (nanofibers) with micron-scale fibers, platelets and 3D particles. Some or all of such NWs (nanofibers), micron-scale fibers, platelets and 3D particles may exhibit: (i) external porosity (accessible by N₂ gas during sorption measurements at 77K) (e.g., may comprise micropores, mesopores, macropores and their various combinations), (ii) internal porosity (inaccessible by N₂ gas during sorption measurements at 77K) (e.g., may comprise micropores, mesopores, macropores and their various combinations), (iii) be dense (not comprise pores) or (iv) any combination of the above. The ratio of internal-to-external pore volume in such particles may vary. The ratio of pore volumes of pores of specific size ranges may vary.

Many of the examples provided below in this disclosure focus on the formation of aluminum (Al) ethoxide NWs as exemplary illustrations of metal alkoxide (or, more generally, metal-organic) NW formation, but it will be appreciated that embodiments of the present disclosure are not limited to Al ethoxide NWs.

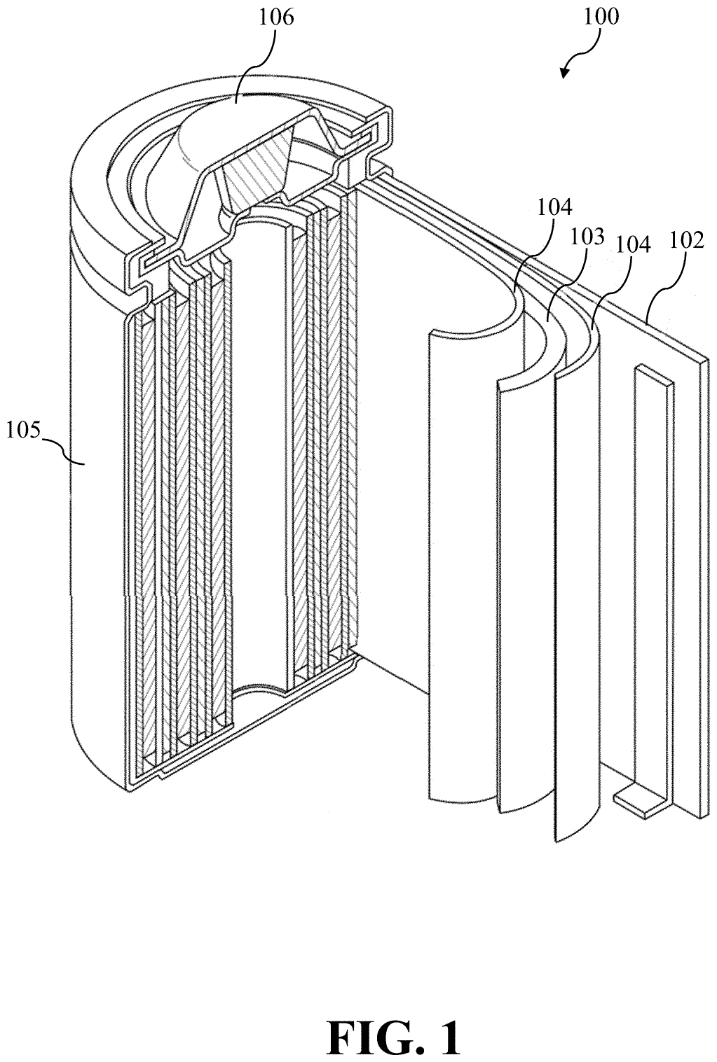

FIG. 1 illustrates an example metal-ion (e.g., Li-ion) battery in which the nanowires, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on or in the anode current collector and the cathode is disposed on or in the cathode current collector.

The present disclosure relates to processes for the efficient formation of nanowires such as Al alkoxide nanowires (e.g., Al ethoxide nanowires), Al oxyhydroxide nanowires (e.g., AlOOH nanowires), Al hydroxide nanowires (e.g., Al(OH)₃ nanowires), and Al oxide nanowires (e.g., Al₂O₃ nanowires) nanowires. Furthermore, the present disclosure relates to processes for making dispersions of such nanowires. Yet furthermore, the present disclosure relates to processes for forming a nanowire separator layer on an anode (e.g., 102) and/or the cathode (e.g., 103) from such nanowire dispersions and the cell and battery designs comprising such. In some implementations, a nanowire separator membrane may be formed by coating a nanowire dispersion on a substrate. Such a nanowire separator membrane may be employed as a separator (e.g., 104) in a lithium-ion battery (e.g., 100). As described in detail hereinbelow, an aerogel may be formed from nanowire dispersions.

Composites may be formed in which additional materials (e.g., polymers, metals, or glasses) are infiltrated into the porous aerogels. For example, a polymer matrix composite may be formed by infiltrating polymers into the porous aerogel.

The disclosed fabrication of aerogels (e.g., alumina (Al₂O₃) or AlOOH or Al(OH)3 NW-comprising aerogels or other NW-comprising aerogels, among others) offers great opportunities for the manufacturing of polymer matrix composites with unique, otherwise unattainable properties.

In some designs, such NW-comprising aerogels may comprise microscopic fibers of similar or different composition (e.g., for enhancing mechanical or thermal or other properties). In some designs, such aerogels (or individual NWs) may be infiltrated with metal or metal carbide or metal oxide nanoparticles. In some designs, such aerogels may comprise micropores (<˜2 nm), mesopores (e.g., ˜2-50 nm) or macropores (e.g., ˜50 nm-˜5 micron) and their various combinations and pore volume ratios. In some designs, such aerogels may be effectively used for thermal insulation applications.

The high mechanical strength of one-dimensional (1D) ceramic nanofibers (often called nanowires (NWs)) allows fabrication of lightweight, high load-bearing and thermally stable materials and composite materials. The reduced size, high surface-to-volume and high aspect ratios enable ceramic NWs to attain magnetic, thermal, optical and electrical, and mechanical properties strikingly different (and often significantly superior for applications) than their conventional micro- and macroscopic counterparts, including micron-scale fibers. These features make ceramic NWs highly attractive for use in electronics, photovoltaics, advanced sensing, electrochemical devices (e.g., batteries including lithium-ion batteries, electrochemical capacitors), and electromechanical devices. In particular, alumina (Al₂O₃) NWs are lightweight (density ˜3.7 g/cc for nonporous NWs) and strong (reported high shear modulus of ˜124 GPa, Young' s modulus of 210-300 GPa, and maximum tensile strength of up to ˜12 GPa), possess a wide band gap (5.1-8.8 eV) and a moderate dielectric constant (ca. 9.8), and exhibit a high thermal stability (up to ˜1200° C.) and a modest thermal conductivity (ca. 18 W m⁻¹K), which are attractive properties for use in microelectronics, aerospace industry, filtration, adsorption, catalysis, thermal insulation, and other important applications. However, conventional synthesis of Al₂O₃ and other ceramic NWs by chemical vapor deposition (CVD), electrodeposition, and other means is rather elaborate, expensive, and difficult to scale.

Significant progress has been made in recent years in the synthesis of a broad range of functional ceramic nanowires (NWs), other metal-comprising (nano)materials, and other metal-comprising (nano)composites. As disclosed, for example, in U.S. Pat. No. 9,994,715 B2 and U.S. Pat. No. 11,214,918 B2, three-dimensional (3D) bulk bimetallic alloys (e.g., aluminum-lithium (Al—Li) alloy, magnesium-lithium (Mg—Li) alloy, zinc-lithium (Zn—Li) alloy) may be directly transformed to metal-organic nanowires upon reaction with an alcohol (e.g., ethanol) at ambient temperatures and ambient pressures. In some implementations, the alloy may be a polycrystalline Al—Li alloy, which is reacted with ethanol to form Al ethoxide nanowires. The use of ceramic nanowires (e.g., Al₂O₃ nanowires) for forming separators (e.g., battery separators) has been disclosed, for example, in US Patent Application Publication No. 2019/0198837 A1. Similar synthesis processes were demonstrated for other alloys such as Mg—Li and Zn—Li. The synthetic concepts were also extended to copper (Cu)-comprising alloys, as disclosed for example in US Patent Application Publication No. 2019/0040497 A1. In some implementations, porous Cu and copper oxide (CuO) nanowires are formed from exposure of copper-calcium (Cu—Ca) alloys to hydrophilic solvents such as water and alcohol.

In the case of forming Al alkoxide NWs by reaction with an alcohol, upon the dissolution of Li component of the Al—Li alloy in anhydrous alcohol, highly reactive Al forms and then transforms into polymeric Al ethoxide. Owing to the accompanied interfacial stresses and the strain energy minimization at the boundary of the metal-to-ethoxide transformation front, the formation of 1D structure of alkoxides becomes thermodynamically and kinetically favorable. The oxide groups serving as good bridging ligands may facilitate the formation of polymeric Al ethoxide NWs. In some designs, the Al ethoxide NWs formed thereby are often present in the form of the insoluble suspension of bundles, which typically need to be separated from the Li-ethoxide/ethanol solution, dried in an inert environment, and further split into individual NWs by bathing in a fresh hot ethanol solution over a period of several hours. After splitting, individualized and dried Al ethoxide NWs can be transformed to a pure alumina ceramic NWs by heating in air. In some cases, the separation of Li ethoxides from the anhydrous alcohol suspension of NWs bundles and further purification and splitting of NWs after the de-alloying process under inert atmosphere are accompanied by an undesirable loss of NWs. In addition to physical losses of small individual NWs during several filtration steps, some Al is believed to be dissolved in the form of semi-soluble mixed Al—Li-ethoxides, thereby reducing attainable yields to ˜85% or below in some implementations.

In some designs, the low oxidation potential of Al (−1.6 V vs. standard hydrogen electrode (SHE) potential) may allow Al to readily react with protic solvents such as water and alcohols, in the presence of heat (in some cases). However, due to surface passivation by the formed aluminum oxide, such a reaction on pure Al generally does not proceed in ambient conditions. In order to overcome this limitation, a synthetic strategy of continuously generating fresh Al surfaces through dissolution of a Li component of Al—Li alloy may be utilized (e.g., as disclosed in U.S. Pat. No. 9,994,715 B2 and U.S. Pat. No. 11,214,918 B2). Here, Li serves as an activator not only by exposing fresh Al surfaces for reaction with alcohols, but also reducing the electrochemical potential of Al further down (e.g., well below −1.6 V vs SHE) and thus significantly enhancing its reactivity. In some implementations, faster reactions with ethanol may be attained when the Li content in the alloy is at least about ˜4 wt. % (an Al—Li alloy with Li mass fraction of about 4 wt. in the Al—Li alloy is referred to as an Al—Li4 alloy), although alloys with smaller Li fractions may also be used in some designs. According to the Al—Li phase diagram, 14.5 at. % (˜4.18 wt. %) of Li is the minimum mass fraction needed to generate Li-rich phases (δ AlLi or δ′ Al₃Li) thermodynamically (e.g., upon very slow cooling). In some implementations, such Li-rich phases may initialize a rapid reaction between Al and ethanol. However, regardless of whether the Li mass fraction in the Al—Li alloy is above or below the threshold for attaining Li-rich phases, the soluble Li ethoxides produced during delithiation in ethanol can make the nanowire purification process an arduous, time-consuming, and costly task, requiring large amount of anhydrous ethanol for a thorough washing that also results in loss of the NWs. In addition, some fraction of Al is believed to be lost due to the formation of mixed Al—Li ethoxides that have significantly higher solubility in ethanol than pure Al ethoxides.

In accordance with some embodiments, water (e.g., deionized water or tap water) is employed as a reactive solvent. An Al—Li alloy is treated with the reactive solvent to form a porous metal comprising Al. One possible hypothesis underlying this synthetic strategy is as follows: if the Li present in the Al—Li alloy, whether in Li-rich phases or grain boundaries, could be rapidly dissolved to produce lightly Li-doped monolithic porous Al, its surface passivation may initially be sufficiently weak to allow reaction with alcohols to generate NWs with improved yield. Furthermore, rapid dissolution of the Li in the Al—Li alloy may be accomplished by exposure of the Al—Li alloy to water.

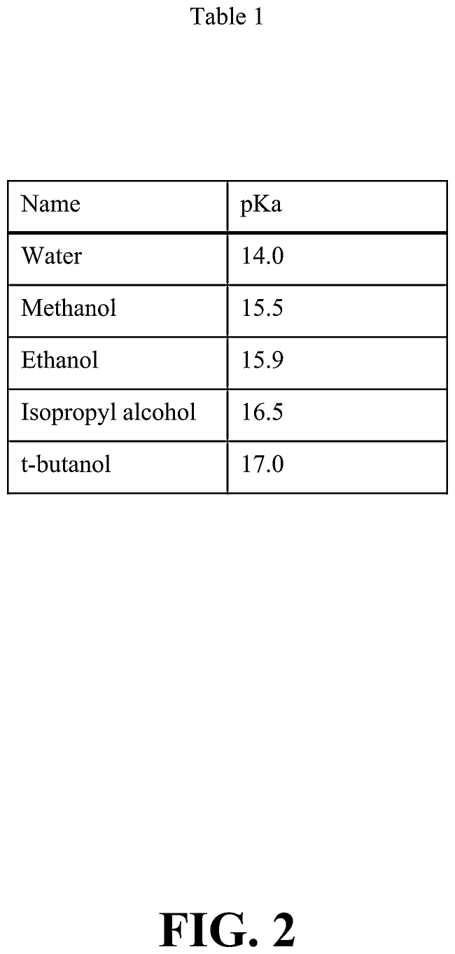

Alcohols are weak Br∅nsted acids (BAs) with pKₐ values in a range of about 15.5 to about 20. The pKₐ values of some common small molecule alcohols (methanol, ethanol, isopropyl alcohol, and t-butanol) are listed in Table 1 of FIG. 2. The pKₐ values of these small molecule alcohols are in a range of about 15.5 to about 17.0. When Al—Li alloys are exposed to small molecule alcohols, delithiation occurs with visible evolution of hydrogen gas, and simultaneously, the Al reacts with the alcohols forming Al alkoxide NWs. On the other hand, strong BAs have pKₐ values of less than 15. An example of a strong BA is water, with a pKₐ value of 14.0 (Table 1 of FIG. 2). When Al—Li alloys are exposed to deionized (DI) water, hydrogen gas is released much more vigorously than in the case of a reaction with small molecule alcohols because of dramatically faster reaction of water with Li (in part, due to its low oxidation potential of −0.98 V vs. SHE). Remarkably, no disintegration of the bulk Al—Li alloy chunks into fine Al hydroxide powders upon Al—Li exposure to DI water was observed. Instead, upon exposure of bulk Al—Li alloy to water (e.g., deionized (DI) water, tap water, etc.), the formation of a bulk porous Al that is very easy to separate from the solution was observed.

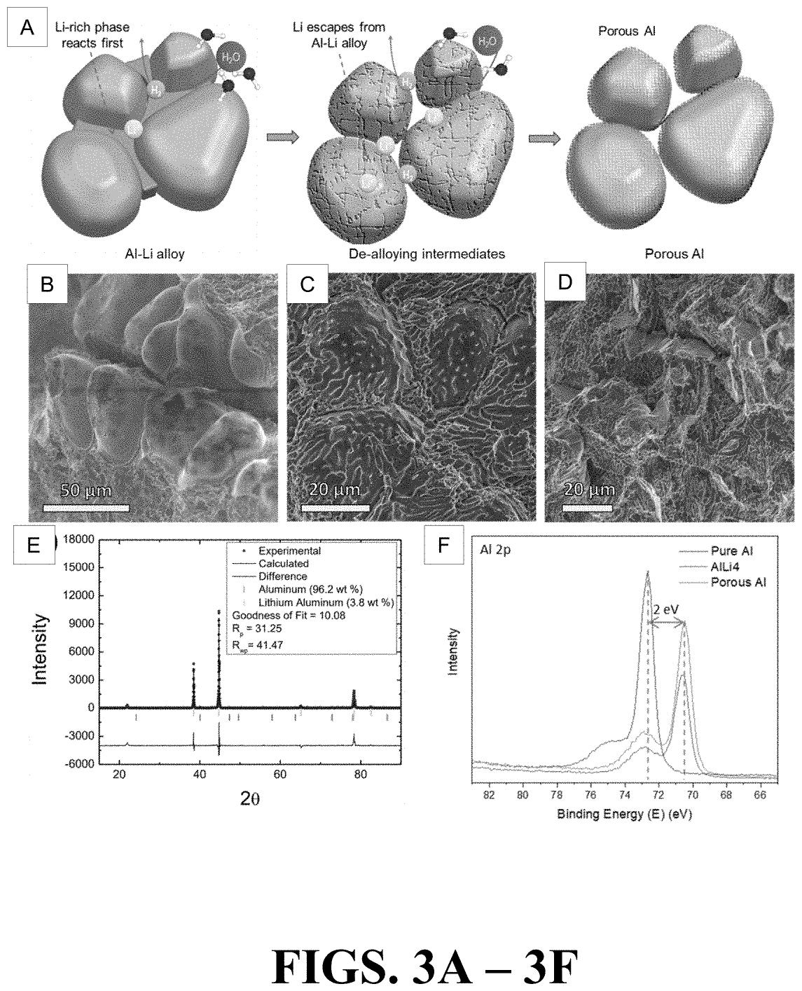

FIG. 3A is a schematic representation of an example process (example reaction) of forming porous Al. In the example shown, a bulk Al—Li alloy is treated with water molecules. The water reacts first with the Li present in a Li-rich phase or at grain boundaries. This reaction results in Li escaping from the Al—Li alloy and the formation of de-alloyed intermediates (herein, the term “de-alloyed intermediate” is used to an intermediate structure that has a lower Li mass fraction than in the original Al—Li alloy). As the reaction proceeds, the intermediates are transformed into porous Al, a porous structure primarily comprising Al, from which a majority of the Li or most of the Li has been removed. Micropores (pores <2 nm), mesopores (2-50 nm pores) and/or some macropores (>50 nm pores) in various volume ratios may be present within such porous Al. In some implementations, each particle of porous Al is a monolithic particle of porous Al. In some implementations, the porous Al particle may be regarded as a particle of Li-doped Al because of the presence of residual Li. The residual Li may range from about 0.01 to about 2 wt. %.

FIG. 3B shows an SEM image of an Al—Li4 alloy, as prepared. The SEM image shows discernible grains and visible Li-rich regions between the grains. Upon immersion of the Al—Li4 alloy chunks into water (e.g., deionized (DI) water, tap water, etc.), the Li-rich regions located at the grain boundaries dissolved rapidly (within 10-20 s). FIG. 3C shows an SEM image of the Al—Li4 alloy after treatment in water (e.g., deionized water) for about 10-20 seconds. Eventually, a porous metallic bulk material is formed and is found submerged in water at the bottom of the reaction vessel. FIG. 3D shows an SEM image of the porous Al after the Al—Li4 alloy has been treated in (e.g., submerged in) water (e.g., deionized (DI) water, tap water, etc.) for about 24 h. Herein, this porous metallic bulk material is referred to as “porous Al” due to the removal of a majority of the Li or most of the Li from the Al—Li alloy, thereby creating a porous structure primarily composed of Al (details of its structure and compositions are reported hereinbelow). Even though surfaces of the grains of Al—Li4 alloy have been etched by water, in some designs, the typical grain sizes of the porous Al sample are in a range of about 20 to about 50 μm in diameter, in the example shown (FIG. 3D).

Upon the dissolution of Li in water, the Al atoms on the Al—Li alloy surfaces form insoluble Al hydroxides, oxides, or oxyhydroxides, covering the surface of the bulk Al—Li alloy at room temperature. This surface layer, however, is not passivating, and allows reactions between the water and the Li remaining inside Al—Li alloy bulk to proceed. In some designs, the passivated Al surface layer may be substantially impermeable to water. In some designs, the passivated Al surface layer may be selectively permeable to Li⁺ (size of about 0.07 nm), but not to Al⁺ (size of about 0.06 nm). Accordingly, in some implementations, the Al hydroxide surface layer prevents continuous Al oxidation, thereby causing porous Al structures to be formed (FIG. 3D). The nitrogen sorption measurement (carried out around 77 K) data of porous Al samples showed a Type II isotherm, a multilayer adsorption typical for a largely macroporous material (herein, the term “macroporous” is used to refer to pores of about 50 nm or greater in pore size). The pore size distribution computed by the BJH (Barrett-Joyner-Halenda) analysis on the nitrogen sorption data shows that the porous Al mainly contains larger pores (e.g., macropores) of about 100 nm to about 200 nm in diameter. However, the pore size distribution may depend on the alloy composition and microstructure and the de-alloy conditions. As such smaller (e.g., <˜100 nm) or larger (e.g., >˜200 nm) may also be formed in porous Al in some designs.

FIG. 3E shows the x-ray diffraction (XRD) data measured on the porous Al sample, as well as the Rietveld refinement thereof. The Rietveld refinement revealed that the porous Al material retained 3.8 wt. % β-AlLi (which contains ˜0.8 wt. % of Li) along with a small quantity of an unknown phase (2θ is ˜22°). The XRD peaks of the binary-phase material are in agreement with Inorganic Crystal Structure Database (ICSD) No. 00-004-0787 of Al and ICSD No. 04-004-3791 of β-AlLi alloy, both indexed in the space group Fm-3m. A comparative XRD analysis between pure Al and porous Al reveals that pure Al is dominated by face centered cubic (FCC)-Al having the (111) facet as the lowest energy, while the dominant facets in the case of porous Al is (200) whose surface free energy is higher than that of (111) facet. Accordingly, the XRD data helps to elucidate the composition of the porous Al. Note that the final grain size and the wt. % of Li in porous Al may vary depending on the initial alloy composition and properties as well as the dealloy conditions (e.g., temperature, time, pressure, fraction of water if water-comprising solvent is used, etc.). In general, in some designs, Li content in porous Al may preferably range from about 0.01 wt. % to about 4 wt. % (e.g., from about 0.01 wt. % to about 0.1 wt. %; or from about 0.1 wt. % to about 1 wt. %; or from about 1 wt. % to about 2 wt. %; or from about 2 wt. % to about 3 wt. %; or from about 3 wt. % to about 4 wt. %). In some designs, the volume average Al grain size in porous Al or porous Al alloy may preferably range from about 20 nm to about 100 micron (e.g., from about 20 nm to about 100 nm; or from about 100 nm to about 500 nm; or from about 500 nm to about 2 micron; or from about 2 micron to about 10 micron; or from about 10 micron to about 100 micron).

FIG. 3F shows the x-ray photoelectron spectroscopy (XPS) data for the Al 2p orbitals measured on pure Al, the Al—Li4 alloy, and the as-synthesized porous Al samples. As shown in FIG. 3F, the binding energy of metallic Al for pure Al is ca. 72.6±0.1 eV. On the other hand, the binding energy of metallic Al for the Al—Li4 alloy and for the porous Al is ca. 70.6 eV±0.1 eV, which is lower than for pure Al by about 2 eV. This binding energy shift (difference) of ca. 2 eV implies that the electron density of Al atoms in porous Al and Al—Li4 alloy is higher than the untreated bulk of pure Al, which may make Al atoms in the porous Al much more reactive than those in pure bulk Al. Accordingly, the XPS measurements provide further insight into the composition of the pure Al, the Al—Li4 alloy, and as synthesized porous Al materials.

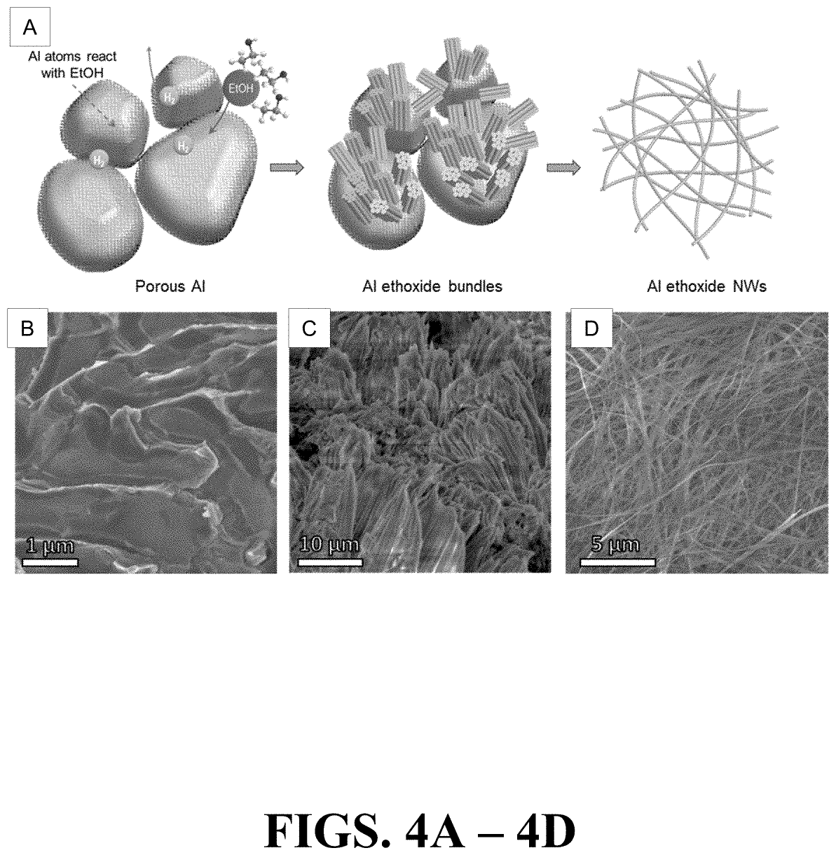

FIG. 4A is a schematic representation of an example process (example reaction) of forming Al ethoxide nanowires. In the example shown, the as-synthesized porous Al (e.g., synthesized as outlined in FIG. 3A) is immersed in ethanol in a reaction vessel and the contents of the reaction vessel are heated to about 60° C. The Al atoms of the porous Al react with ethanol. Initially, bundles of Al ethoxide nanowires are formed, and as the reaction proceeds, the bundles of Al ethoxide nanowires are transformed into well-dispersed Al ethoxide nanowires including individual nanowires. The reaction was monitored by isolating the intermediate products at different time intervals from reaction start and imaging the isolated intermediate products by SEM. FIG. 4B is an SEM image of an Al ethoxide forest formed after the first 5 minutes of a reaction between porous Al and ethanol. At this initial stage (e.g., 5 min after reaction start), a thin layer of NW forests covered the porous Al surfaces (FIG. 4B). FIG. 4C is an SEM image of Al ethoxide nanowires after about one hour of growth in ethanol. As the reaction proceeded, the NWs continued to grow. After about 1 h of growth in ethanol, longitudinally-grown forests of Al ethoxide NWs (bundles of elongate Al ethoxide nanowires) were observed over the porous Al surfaces (FIG. 4C). At this point in time, the Al ethoxide NWs (bundles) were still attached to the porous Al surfaces. There was sufficient interstitial space between the bundles of Al ethoxide nanowires to permit rapid infiltration of ethanol into the interior of the porous Al. FIG. 4D is an SEM image of Al ethoxide nanowires after about 96 h of growth in ethanol. The reaction continued until all porous Al materials were converted into Al ethoxide NWs, while the bundles of Al ethoxide nanowires gradually detached and separated into individual Al ethoxide NWs (FIG. 4D). A hypothesis for the mechanism of nanowire formation may be proposed as follows. Polymeric Al ethoxide (Al ethoxide connected by polymer chains) are formed upon exposure of Al to ethanol. The large volume expansion associated with polymeric Al ethoxide formation from Al results in large elastic stresses at the boundary of the phase transformation front. Such strain energy may be reduced by the formation of nanowires. One factor to control the NW diameter is a balance between the specific strain energy (which decreases with smaller NW diameter) and the specific surface energy of NWs (which increases with smaller NW diameter). According to a previously disclosed synthetic pathway (as disclosed in U.S. Pat. No. 11,214,918 B2, for example), bulk Al metal is treated with an alcohol (e.g., ethanol) to form polymeric Al alkoxide (e.g., polymeric Al ethoxide), and then the polymeric Al alkoxide (e.g., polymeric Al ethoxide) is treated again in an alcohol (e.g., ethanol) to form Al alkoxide nanowires (e.g., Al ethoxide nanowires).

Herein, Al ethoxide nanowires that are produced according to this previously reported synthetic pathway are sometimes referred to as “E-NWs” because of the “ethanol-only” feature of the process. In contrast, Al ethoxide nanowires that are produced according to the synthetic pathway herein are sometimes referred to as “WE-NWs” because of the “water-and-ethanol” feature of the process. In some implementations, the WE-NW pathway attained a 60% reduction in processing time, a lower total cost of raw materials and process chemicals, and an improvement in yield of 9%, compared to the E-NW pathway. The process for forming Al ethoxide nanowires by the E-NW pathway includes the following two parts: (1) a water-mediated rapid hydrolysis of the Al—Li alloy to produce a monolithic porous Al, and (2) a reaction of the monolithic porous Al with ethanol to produce the Al ethoxide NWs. The monolithic nature of the porous Al allows easy purification (e.g., removal) of the soluble LiOH byproducts, which in turn simplifies the overall purification of the produced NWs and affords higher yields.

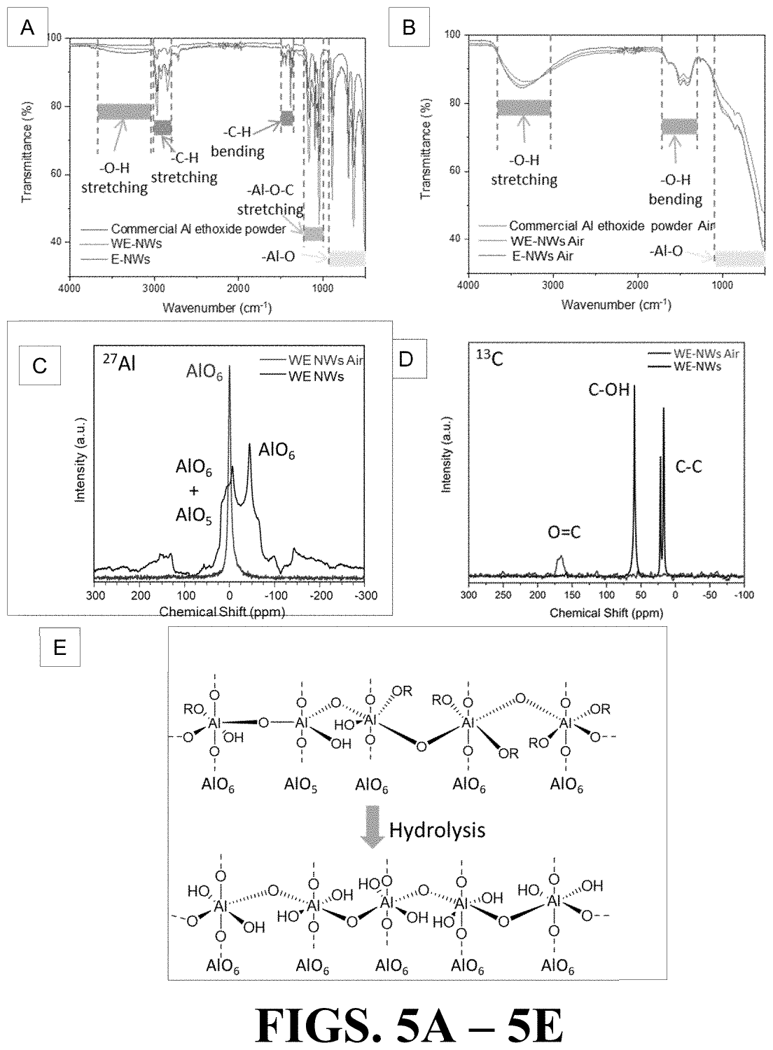

FIG. 5A shows FT-IR spectra on commercially available Al ethoxide powder, as-synthesized WE-NWs according to some embodiments, and as-synthesized E-NWs. The FT-IR data reveal that the vibrational features of the WE-NWs and E-NWs are quite similar, suggesting that their chemical structures may be similar (FIG. 5A). The C-H stretching bands in the range of 2800-3000 cm⁻¹ and C-H bending bands in the range of 1340-1500 cm⁻¹ correspond to the ethoxide/ethanol moieties present in the NWs. The strong peaks in the fingerprint region (about 1200 cm⁻¹ to about 700 cm⁻¹) are characteristic vibrations of —Al—O—C— moieties and Al—O bonds. Specifically, the observed bands at 1170, 1099, and 1049 cm⁻¹ are due to the characteristic —Al—O—C stretching vibrations in Al ethoxides. The band at 892 cm⁻¹ may be attributed to the stretching vibrations of Al—O bonds in which the Al is in pentahedral geometry (AlO₅), and the bands at 700, 642, and 500 cm⁻¹ may be attributed to the stretching of the Al—O bonds in which Al is in octahedral disposition (AlO₆). The FT-IR spectrum of commercial Al ethoxide powders exhibits all the above bands at the respective positions (FIG. 5A), which confirm the Al ethoxide compositions of the WE-NWs and E-NWs with a high degree of confidence.

As-synthesized Al ethoxide NWs are prone to hydrolysis by water present in ambient air or upon exposure to a water-comprising solvent (e.g., ethanol, etc.), but they can be typically annealed in either open air (which may comprise O₂, N₂, CO₂, H₂O, etc.) or in argon (Ar) or nitrogen (N₂) or carbon dioxide (CO2)—comprising environment to convert, for example, into AlOH, Al(OH)₃ or Al₂O₃ NWs. The question of whether a short or prolonged exposure to air/moisture is detrimental to, beneficial to, or has little or no impact on the conversion of Al alkoxide NWs to Al oxide NWs (including alumina ceramic NWs) is of scientific and commercial significance. In some designs, open air exposure may result in a gradual weight reduction of Al ethoxide NWs (both WE-NWs and E-NWs) and commercial Al ethoxide particles because of the replacement of ethoxy groups by hydroxyl groups resulting from a chemical reaction between the NWs and water. After 5 h, the mass losses for the WE-NWs, E-NWs, and commercial Al ethoxide were similar (˜65%). Calculations based on stoichiometry of the hydrolysis reaction and thermogravimetric analysis (TGA) suggest that initial Al ethoxide samples (WE-NWs, E-NWs, and commercial Al ethoxide) undergo a spontaneous partial transformation into Al hydroxides. It is estimated that the composition of the as-synthesized WE-NW-type Al ethoxide nanowires may be expressed by a stoichiometric formula of AlO_{0.62}(EtO)_{1.76} (herein, EtO is an abbreviation of ethoxide). Furthermore, the Al hydroxides may react with atmospheric CO₂ to form a carbonate-like moiety in the final product (e.g., Al hydroxide nanowires). It is estimated that the stoichiometric formula of these Al hydroxide nanowires may be expressed as Al(OH)₃·0.86(CO₂). Note that the composition of such NWs may depend strongly on synthesis and treatment conditions and thus may vary.

FIG. 5B shows FTIR spectra as measured on commercially available Al ethoxide powder, WE-NW-type Al ethoxide nanowires, and E-NW-type Al ethoxide nanowires, respectively, after exposure to ambient air for 24 h. These FTIR measurements were undertaken to gain more insight into the chemical nature of the hydrolyzed product. In the example shown, the signals are quite broad, suggesting a wider variation of chemical environments in the overall structure. The bands of O—H stretching (above 3000 cm⁻¹) and bending (broad peaks in a range from 1300 to 1700 cm⁻¹) appeared prominently. The peaks below 1200 cm⁻¹ in the fingerprint region are of Al—O bonds. The bands of pentahedral Al (AlO₅) (at 892 cm⁻¹) are diminished but those of the octahedral Al (AlO₆) below 700 cm⁻¹ are still clearly visible, which suggests that the hydrolysis reaction tends to change the coordination environment of the 4-coordinated Al centers but tends to preserve the coordination environment of the 6-coordinated Al centers. FIG. 5C shows ²⁷Al MAS solid-state NMR spectroscopy data for Al ethoxide nanowires (WE-NWs) before and after hydrolysis (exposure to ambient air), respectively. The ²⁷Al MAS solid-state NMR data shown in FIG. 5C further supports the foregoing FTIR analysis. In the pristine Al ethoxide NWs (before hydrolysis), the Al atoms present in 6-coordinated state (Al^{V1}) appear upfield shifted in the range −60 to 0 ppm, while those in 5-coordinated state (Al^{V}) appear as a shoulder in the chemical shift range between 0 and 25 ppm, and those in 4-coordinated state (Al^{IV}) appears as a complex set of peaks ranging between 200 and 120 ppm. The ²⁷Al NMR spectrum of the hydrolyzed NWs sample, in contrast, suggests that only the 6-coordinated Al (Al^{VI}) centers are present, which includes non-bridging OH groups as well as bridging O groups in the hydrolyzed NWs. These groups contribute to the strong bridging bonds between Al and oxygen donors (e.g., ROH, RO, O). FIG. 5D shows ¹³C cross-polarization (CP) MAS solid-state NMR spectroscopy data for Al ethoxide nanowires (WE-NW-type) before and after hydrolysis (in this case, by exposure to ambient air), respectively. In the ¹³C CP-MAS solid-state NMR spectra of the as-synthesized WE-NWs (before hydrolysis) (FIG. 5D), the peaks attributable to the terminal C atoms of the terminal CH3 moiety (appearing at 16.9 and 21.6 ppm) and the single peak attributable to the CH2 moiety (appearing at 59.4 ppm) of the ethanol/ethoxide are observed. In contrast to the foregoing, all of these signature peaks for ethanol/ethoxide are not visible in the hydrolyzed nanowire sample after 24 h of hydrolysis (FIG. 5D). Interestingly, a weak broad peak at ca. 165 ppm, suggestive of a C═O group, has appeared. The presence of a C═O group would be consistent with the proposed mechanism of CO₂ adsorption and formation of carbonate-like moieties in Al hydroxide nanowires based on the foregoing stoichiometry and TGA discussion.

FIG. 5E is a schematic representation, at a molecular level, of a hydrolysis process that converts Al alkoxide nanowires to Al hydroxide nanowires. This schematic representation has been developed after considering the foregoing FT-IR and NMR results on Al ethoxide nanowires. The as-synthesized Al ethoxide NWs likely contain octahedral AlO₆ and pentahedral AlO₅. The alkoxide groups (e.g., ethoxide groups) are shown as OR. Upon hydrolysis, the larger alkoxide groups are replaced by the smaller —OH groups. Upon hydrolysis, additional water molecules can coordinate on the 5-coordinated Al centers to transform them into fully octahedral Al centers (AlO₅) which are more stable. It has been observed that the hydrolysis rate of the WE-NW-type Al ethoxide nanowires is greater (faster rate of hydrolysis) than that of the commercial Al ethoxide powder, which may be attributed to the smaller diameter and higher specific surface area of the example NWs that enable faster transport of the diffusing water molecules to the reaction sites. In the examples shown, the hydrolysis process does not destroy or otherwise alter the one-dimensional (1D) structure of the WE-NWs. This observation has important implications for the handling and storage of the nanowires; accordingly, processing of the nanowires in an inert environment might not be necessary, in some implementations. Furthermore, it has been observed that the fully hydrolyzed WE-NWs may be re-dispersed in water without observable shape distortion, which opens up possibilities of their use in innovative chemical and materials processes in aqueous media.

One attractive application of the NWs is their use in battery separators or battery separator layers (e.g., for Na-ion or Li-ion or other batteries). In some designs, such a NW-comprising layer may be deposited on one or both surfaces of a porous polymer separator base layer. In some designs, such a NW-comprising layer may be deposited on the anode. In some designs, such a NW-comprising layer may be deposited on the cathode. NW-comprising separators may enable better thermal stability, faster charging and higher energy density to batteries.

Another attractive application of NWs is in the formation of porous aerogels. Due to the 1D structure of ceramic NWs (e.g., Al₂O₃ NWs), ceramic NWs enable formation of highly porous structures as they form a continuous interconnected network. One common approach of constructing aerogels from 1D nanomaterials is lyophilization (also referred to as freeze-drying), a process that allows the solvent molecules to go directly from the solid phase to the gas phase without passing through the liquid phase (sublimation), which helps to avoid collapse of the aerogel matrix from the action of capillary forces. The hydrolyzed NWs being highly dispersible in water (much more dispersible than, say, Al₂O₃ NWs or Al ethoxide NWs in water) and water having a relatively high freezing point (about 0° C. under ambient pressure) (e.g., compared to ethanol which has a freezing point of about −114.6° C. under ambient pressure) make Al hydroxide NWs superior to Al ethoxide or Al oxide (Al₂O₃) NWs for aerogel formation. AIOOH NW-based aerogels may also be similarly produced.

One attractive application of NW-comprising aerogels is in the formation of thermal insulation material. Another attractive application of NW-comprising aerogels is in the formation of polymer composite materials. Depending on the NW properties and composite preparation and composition, such composites may exhibit better mechanical properties, better thermal stability and either higher or lower thermal conductivity than pure polymer materials.

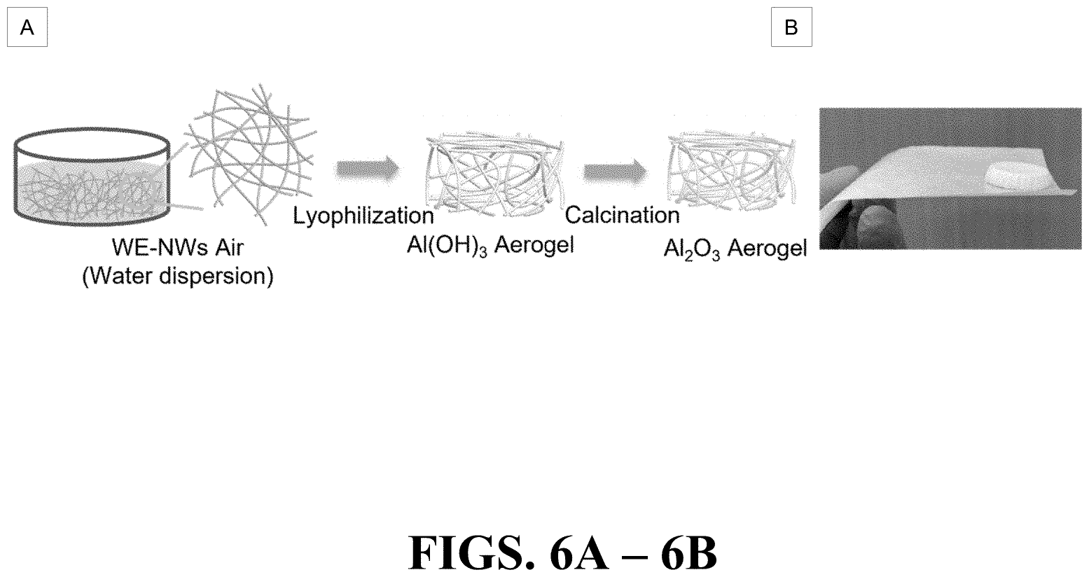

FIG. 6A is a schematic representation of a process of forming an aerogel (e.g., alumina (Al₂O₃) aerogel) from a nanowire dispersion (e.g., aqueous dispersion of Al-hydroxide nanowires). Initially, hydrolyzed Al hydroxide NWs (WE-NWs) were vortexed in water to form a uniform dispersion (operation 1), which was frozen inside a cylindrical container (operation 2) and then freeze-dried at a temperature of around −40° C. (operation 3) to form disc-shaped aerogels having a network of hydrolyzed NWs (operation 4). Subsequently, the hydrolyzed NWs aerogels were annealed in air at elevated temperatures to form amorphous- and γ-Al₂O₃ NWs aerogels (calcination, operation 5), which was confirmed by XRD analyses. Remarkably, it was found that this annealing operation does not damage the overall aerogel structure or the individual NWs despite the stresses associated with volume changes. FIG. 6B shows a photo of the alumina (Al₂O₃) NW aerogel after annealing. The as-produced alumina aerogel was observed to be lightweight, soft, chemically stable, mechanically robust, and free of color change or shape deformation in air for months.

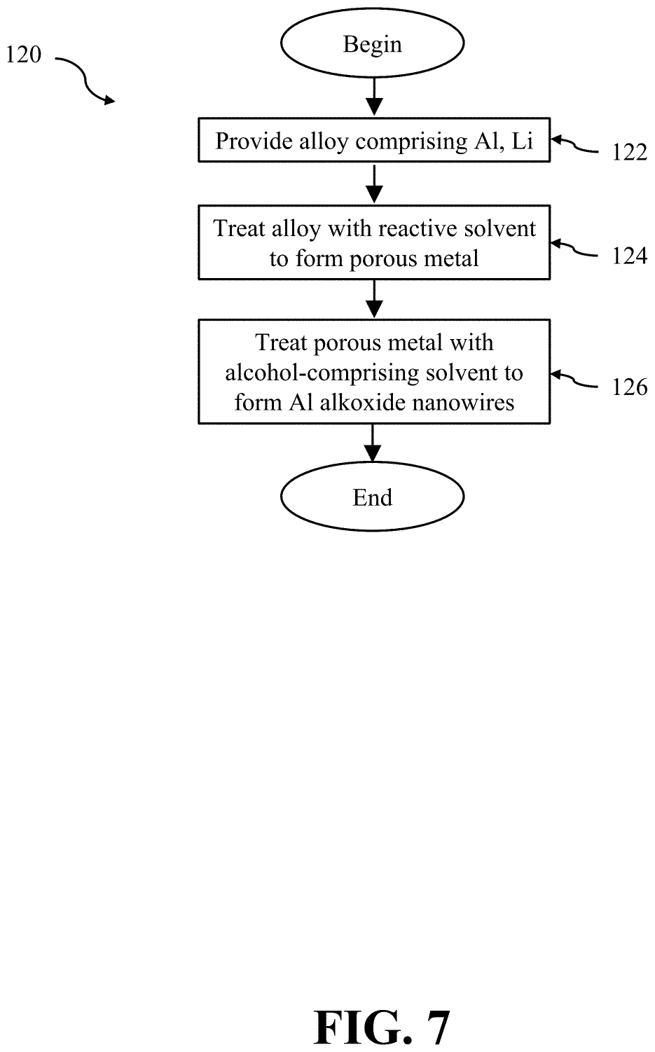

FIG. 7 is a flow diagram of a process 120 of making Al alkoxide nanowires according to some embodiments. An example process of forming Al ethoxide NWs (WE-NWs) has been described (FIGS. 3A, 4A). Process 120 includes operations 122, 124, and 126. Operation 122 includes providing an alloy comprising aluminum (Al) and lithium (Li). The alloy may be a binary alloy (e.g., Al—Li) although higher-order alloys may also be employed. Since Li is more expensive than Al, and Li is removed from the alloy to form porous Al (delithiation), it is preferable to use alloys comprising Al and Li in which the mass fraction (or atomic fraction) of Li in the alloy is quite low (e.g., about 10 wt. % or lower). In the example processes, Al—Li alloys with a Li mass fraction of about 4 wt. % in the alloy were used. In other implementations, alloys with Li mass fractions in a range of about 4 to about 6 wt. %, or about 6 to about 8 wt. %, or about 8 to about 10 wt. % may be used. In addition, it has been observed that delithiation may proceed in alloys with lower Li mass fractions. Accordingly, in some implementations, alloys comprising Al and Li (e.g., Al—Li alloys) with Li mass fractions in a range of about 1 to about 2 wt. %, or about 2 to about 3 wt. %, or about 3 to about 4 wt. % may be used. In some implementations, alloys comprising Al and Li (e.g., Al—Li alloys) with Li mass fractions of about 1 wt. % and less may be used, such as in a range of about 0.1 to about 0.3 wt. %, or about 0.3 to about 0.7 wt. %, or about 0.7 to about 1.0 wt. %.

Operation 124 includes treating the alloy comprising Al and Li (from operation 122) with a reactive solvent to form a porous metal comprising Al. Herein, the term “reactive solvent” is used to refer to a solvent (including a solvent mixture) exhibiting sufficient reactivity, such that when the alloy comprising Al and Li is exposed to the solvent, a porous metal comprising Al is formed. In some embodiments, the reactive solvent has a pKₐ value at 25° C. that is less than 15. In some implementations, the reactive solvent has a pKₐ value at 25° C. of about 14. In some implementations, the reactive solvent has a pKₐ value at 25° C. of greater than 8 and less than 15. In some implementations, the reactive solvent has a pKₐ value at 25° C. of greater than 10 and less than 15. In some implementations, the reactive solvent has a pKₐ value at 25° C. of greater than 12 and less than 15. In some implementations, the reactive solvent comprises water (including deionized water or tap water). In some implementations, the reactive solvent is water (including deionized water or tap water). The porous Al shown in FIGS. 3A and 3D is an example of a porous metal comprising Al. In some implementations, porous Al may comprise Li with (preferably) Li mass fractions of about 1.5 wt. % and less may be used, such as in a range of about 0.00 to about 0.01 wt. %, or about 0.01 to about 0.05 wt. %, or about 0.05 to about 0.1 wt. % or from about 0.1 to about 0.3 wt. %, or about 0.3 to about 0.7 wt. %, or about 0.7 to about 1.0 wt. %, or about 1.0 to about 1.5 wt. %.

Operation 126 includes treating the porous metal (from operation 124) with an alcohol-comprising solvent to form the Al alkoxide nanowires. According to the example process illustrated in FIG. 4A, ethanol is an example of the alcohol-comprising solvent and Al ethoxide nanowires are an example of Al alkoxide nanowires. For example, the alcohol-comprising solvent may comprise ethanol and other solvent components. In other implementations, the alcohol-comprising solvent may comprise another alcohol such as methanol, propanol (e.g., isopropyl alcohol), and butanol (e.g., t-butanol). The specific Al alkoxide nanowires that are formed at operation 126 depends upon the specific alcohol (in the alcohol-comprising solvent) that reacts with the porous Al. Accordingly, if methanol reacted with the porous Al, Al methoxide nanowires would be formed. If ethanol reacted with the porous Al, Al ethoxide nanowires would be formed. FIG. 4D illustrates an example of Al alkoxide nanowires (in the example shown, Al ethoxide nanowires) made in accordance with the process 120.

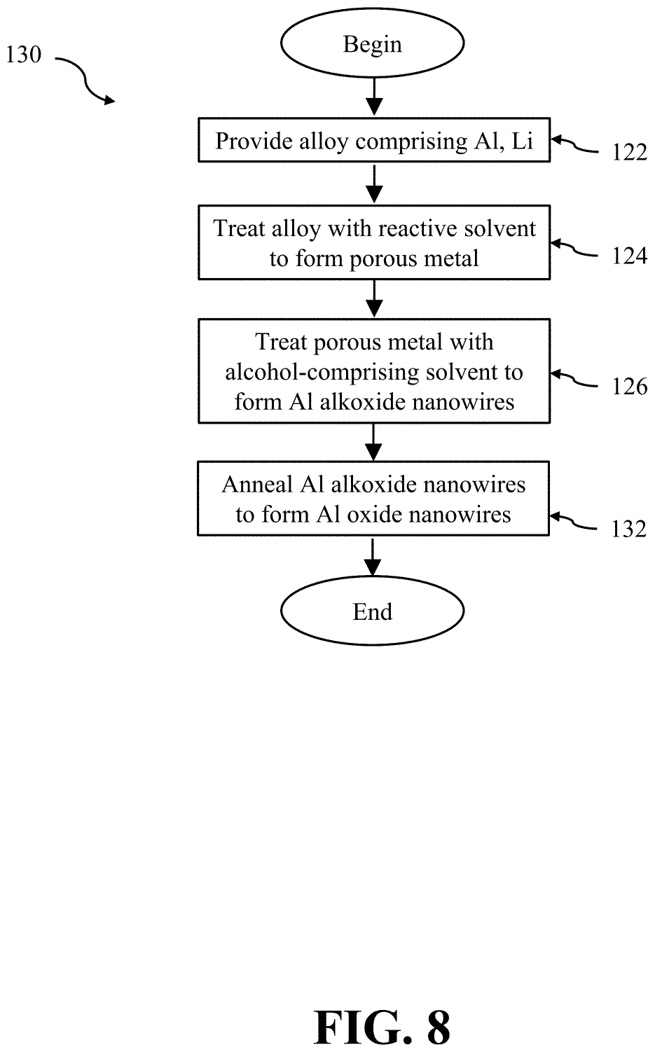

FIG. 8 is a flow diagram of a process 130 of making Al oxide nanowires according to some embodiments. Process 130 includes operations 122, 124, 126, and 132. Operations 122, 124, and 126 have been described in the foregoing discussion of process 120 of FIG. 7, for making Al alkoxide nanowires. Operation 132 includes annealing the Al alkoxide nanowires (e.g., from operation 126) to form the Al oxide nanowires. In some implementations, the annealing may be carried out at a temperature in a range of about 300° C. to about 1000° C. (e.g., in a range of about 300° C. to about 400° C., or in a range of about 400° C. to about 500° C., or in a range of about 500° C. to about 600° C., or in a range of about 600° C. to about 700° C., or in a range of about 700° C. to about 800° C., or in a range of about 800° C. to about 900° C., or in a range of about 900° C. to about 1000° C.). In some implementations, the Al oxide nanowires comprise Al₂O₃ (alumina), such that at least about 90 mol. % of the Al alkoxide is converted to Al₂O₃ by thermal treatment (annealing) in suitable environments. In some implementations, at least about 95 mol. % of the Al alkoxide is converted to Al₂O₃ by annealing. In some implementations, at least about 99 mol. % of the Al alkoxide is converted to Al₂O₃ by annealing. In some implementations, at least about 99.9 mol. % of the Al alkoxide is converted to Al₂O₃ by annealing. In some implementations, at least some of the residual Al alkoxide that is not converted to Al oxide by annealing (operation 132) may be converted to other forms, such as Al hydroxide by exposure to a hydrolyzing environment (e.g., ambient environment). Accordingly, the product of process 130 may include materials other than Al oxide nanowires and Al alkoxide nanowires, such as Al hydroxide nanowires. In other designs (e.g., by selecting suitable treatments in H₂O-comprising environments), NWs may primarily comprise Al(OH)₃ or AlOOH.

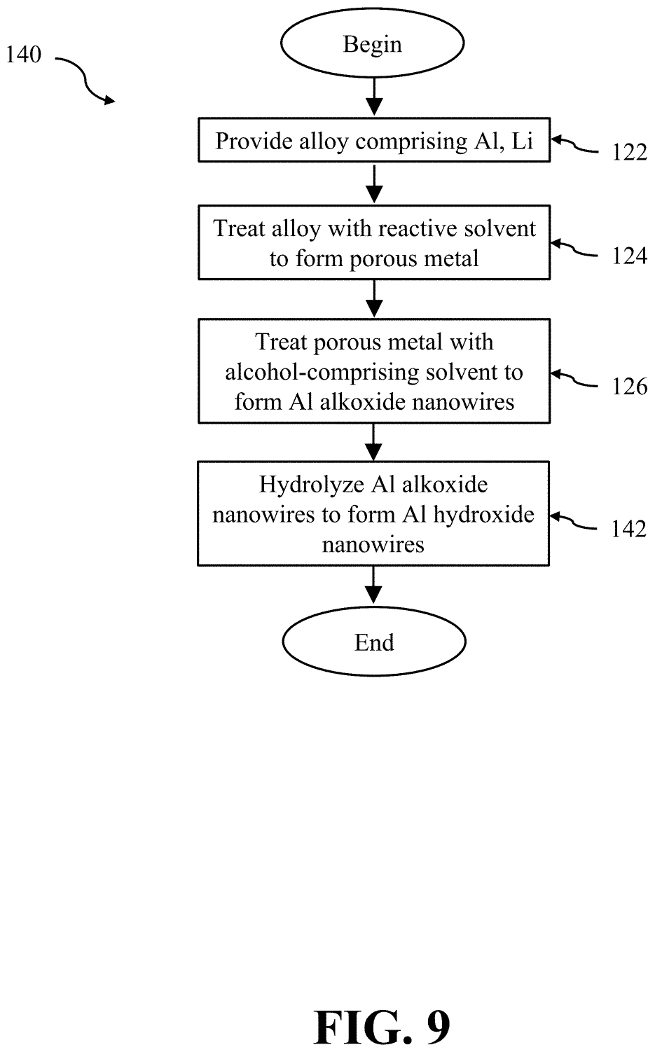

FIG. 9 is a flow diagram of a process 140 of making Al hydroxide nanowires according to some embodiments. Process 130 includes operations 122, 124, 126, and 142. Operations 122, 124, and 126 have been described in the foregoing discussion of process 120 of FIG. 7, for making Al alkoxide nanowires. Operation 142 includes hydrolyzing the Al alkoxide nanowires (e.g., from operation 126) in a hydrolyzing environment to form the Al hydroxide nanowires. An example of a hydrolyzing environment is ambient air. In other implementations, the hydrolyzing environment may be ambient air that has been humidified. In other implementations, the hydrolyzing environment may be ambient air that has been humidified and heated. In some implementations, the Al hydroxide nanowires may comprise Al(OH)3. In addition, other species such as CO2 may be present in the Al hydroxide nanowires (e.g., Al(OH)₃·x(CO₂), where x is in a range from about 0.1 to about 1.0, or about 0.8 to about 0.9).

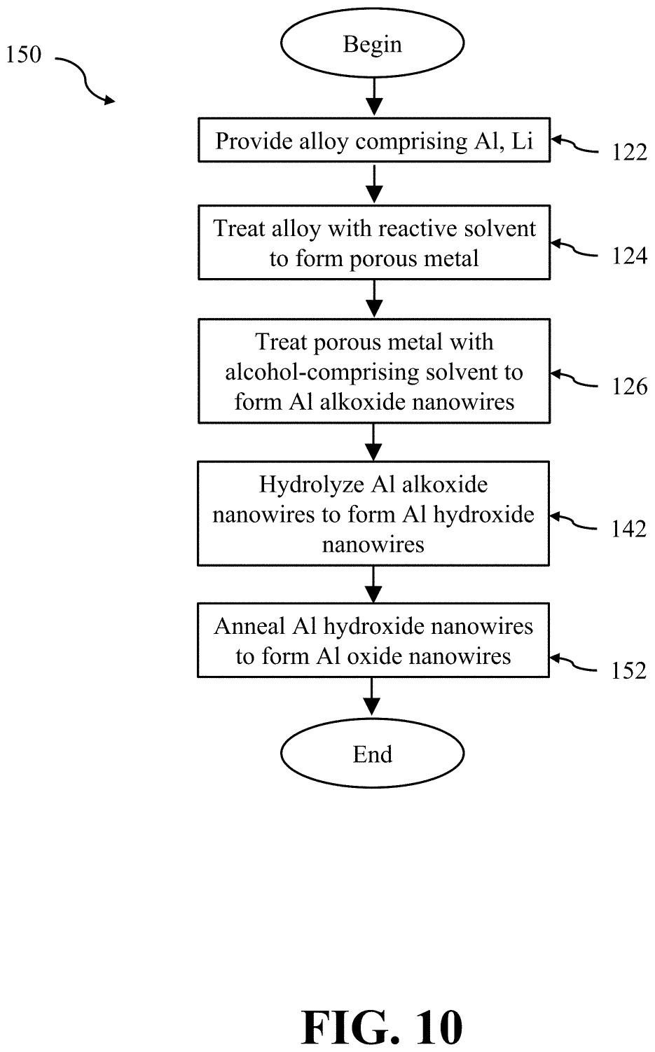

FIG. 10 is a flow diagram of a process 150 of making Al oxide nanowires according to some embodiments. Process 150 includes operations 122, 124, 126, 142, and 152. Operations 122, 124, 126, and 142 are as described for process 140 of FIG. 9, for making Al hydroxide nanowires. Operation 152 includes annealing the Al hydroxide nanowires (e.g., from operation 142) to form the Al oxide nanowires. In some implementations, the annealing may be carried out at a temperature in a range of about 300° C. to about 1000° C. (e.g., in a range of about 300° C. to about 400° C., or in a range of about 400° C. to about 500° C., or in a range of about 500° C. to about 600° C., or in a range of about 600° C. to about 700° C., or in a range of about 700° C. to about 800° C., or in a range of about 800° C. to about 900° C., or in a range of about 900° C. to about 1000° C.). In some implementations, the Al oxide nanowires comprise Al₂O₃ (alumina), such that at least about 90 mol. % of the Al hydroxide is converted to Al₂O₃ by annealing. In some implementations, at least about 95 mol. % of the Al hydroxide is converted to Al₂O₃ by annealing. In some implementations, at least about 99 mol. % of the Al hydroxide is converted to Al₂O₃ by annealing. In some implementations, at least about 99.9 mol. % of the Al hydroxide is converted to Al₂O₃ by annealing.

Nanowires (e.g., alkoxide nanowires, hydroxide nanowires, oxyhydroxide, oxide nanowires) may be fabricated in accordance with some embodiments. In some embodiments, a width (e.g., a diameter) of an individual nanowire may be in a range of about 10 nm (0.01 μm) to about 1 μm. Accordingly, in some embodiments, an average width (e.g., an average diameter) of a population of nanowires may be in a range of about 10 nm (0.01 μm) to about 1μm. In some embodiments, a length of an individual nanowire may be in a range of about 100 nm (0.1 μm) to about 1000 μm (in some designs, in a range of about 100 nm to about 100 μm). Accordingly, in some embodiments, an average length of a population of nanowires may be in a range of about 100 nm (0.1 μm) to about 1000 μm (in some designs, in a range of about 100 nm (0.1 μm) to about 100 μm. The volume fraction of nanowires having different ranges of length may vary. In some embodiments, an aspect ratio (length to width) of an individual nanowire may be in a range of about 10 to about 100,000 (in some designs, in a range of about 10 to about 10,000), or in a range of 100 to 1000. Accordingly, in some embodiments, an average aspect ratio of a population of nanowires may be in a range of about 10 to about 100,000 (in some designs, in a range of about 10 to about 10,000), or in a range of about 100 to about 1000.

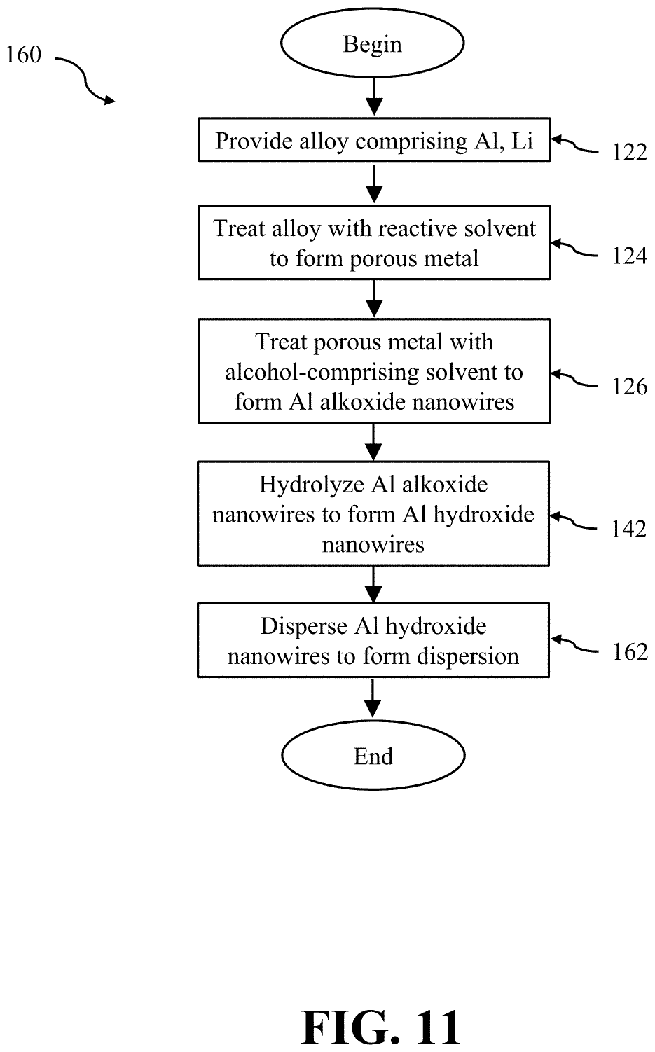

FIG. 11 is a flow diagram of a process 160 of making a dispersion of Al hydroxide nanowires according to some embodiments. Process 160 includes operations 122, 124, 126, 142, and 162. Operations 122, 124, 126, and 142 are as described for process 140 of FIG. 9, for making Al hydroxide nanowires. Operation 162 includes dispersing the Al hydroxide nanowires (e.g., from operation 142) in an aqueous solvent to form the nanowire dispersion. The aqueous solvent may comprise water and/or may be water (e.g., deionized water, tap water, etc.). Note that a mixture of water and one, two or more other solvent(s) may be used in some designs.

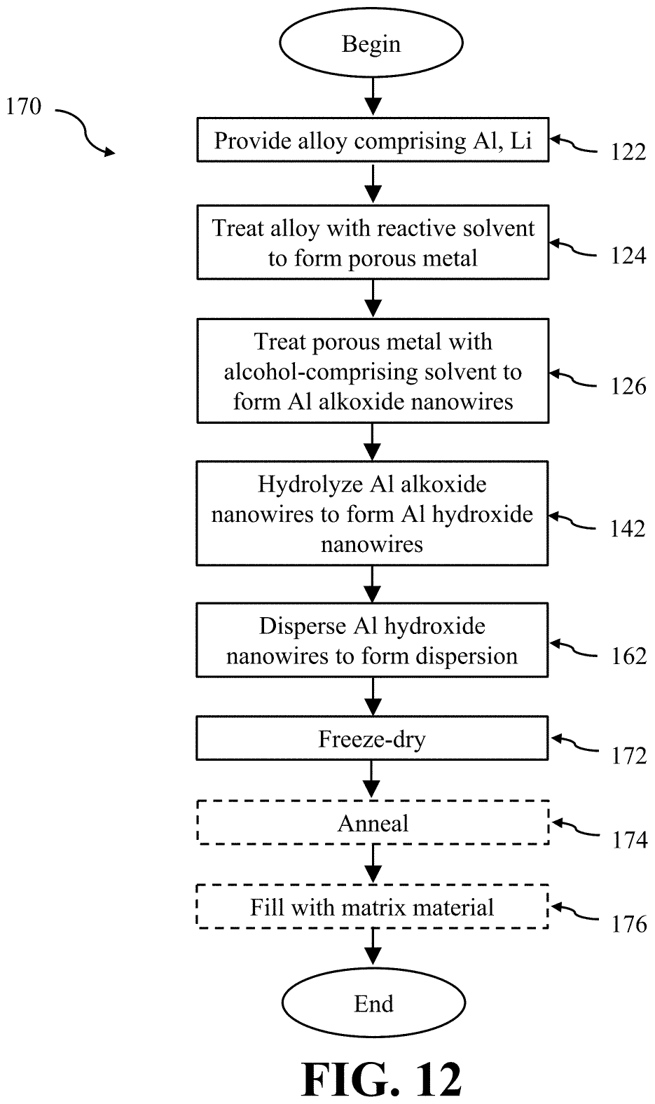

FIG. 12 is a flow diagram of a process 170 of making an aerogel according to some embodiments. Process 170 includes operations 122, 124, 126, 142, 162, 172, 174, and 176. Operations 122, 124, 126, 142, and 162 are as described for process 160 of FIG. 11, for making a dispersion of Al hydroxide (or oxyhydroxide) nanowires. Operation 172 includes carrying out a freeze-drying (lyophilization) treatment on the dispersion of Al hydroxide (or oxyhydroxide) nanowires (e.g., from operation 142) to form the aerogel. During freeze-drying treatment, the dispersion of Al hydroxide (or oxyhydroxide) nanowires undergoes freezing, reduction in pressure (e.g., in a range of about 1 to about 10 millibar), and subsequent application of sufficient heat to cause sublimation of the solvent molecules. Subsequently, operations 174 and/or 176 may optionally be carried out. Operation 174 includes annealing the aerogel (e.g., from operation 172). In some implementations, the annealing may be carried out at a temperature in a range of about 300° C. to about 1000° C. (e.g., in a range of about 300° C. to about 400° C., or in a range of about 400° C. to about 500° C., or in a range of about 500° C. to about 600° C., or in a range of about 600° C. to about 700° C., or in a range of about 700° C. to about 800° C., or in a range of about 800° C. to about 900° C., or in a range of about 900° C. to about 1000° C.). The aerogel that is formed at operation 172 comprises Al hydroxide (or oxyhydroxide) nanowires. However, for some applications, aerogels comprising Al oxide (e.g., alumina) aerogels may be desired. Accordingly, the annealing operation (operation 174) may be employed to convert the Al hydroxide nanowires in the aerogel to Al oxide nanowires. Operation 176 includes filling the aerogel (e.g., from operation 172 or operation 174) with a matrix material. A wide variety of matrix materials may be suitable. For example, polymers, metals, and/or glasses may be used as a matrix material. For example, a polymer solution or a polymer precursor (e.g., a polymerizable oligomer or monomer, in liquid form) may be infiltrated into the aerogel. In the case of a polymer solution, the solvent may be dried after the polymer solution has infiltrated into the aerogel. In the case of a polymer precursor, a polymerizing energy source (e.g., heat, ultraviolet radiation, electron beam) may be applied to cause the polymer precursor to polymerize after the polymer precursor has infiltrated into the aerogel. Accordingly, a polymer network is formed in the void space (pore space) of the aerogel. An aerogel that comprises such a polymer network infiltrated therein may be referred to as a polymer matrix composite.

The foregoing process 170 employs a dispersion of Al hydroxide (or oxyhydroxide) nanowires. It has been observed that the Al hydroxide may be readily dispersed in water and other aqueous solvents. Alternatively, dispersions of Al alkoxide nanowires or Al oxyhydroxide or Al oxide nanowires may be used to form aerogels. In the former case, Al alkoxide nanowires may be provided (e.g., according to process 120) and a dispersion of Al alkoxide nanowires may be made using a suitable solvent. In the latter case, Al oxide or Al oxyhydroxide nanowires may be provided (e.g., according to process 130 or process 150) and a dispersion of Al oxide or Al oxyhydroxide nanowires may be made using a suitable solvent. The dispersion of Al alkoxide nanowires or Al oxyhydroxide or Al hydroxide or Al oxide nanowires may undergo freeze-drying (analogous to operation 172), and optionally, annealing (analogous to operation 174) and infiltration of matrix material (analogous to operation 176). In some designs, macroscopic fibers (e.g., with average diameters in the range from about 1 micron to about 100 micron; with average length in the range from about 10 micron to about 1 meter) of similar or different composition may be added into nanowires to form aerogels with enhanced mechanical or other properties.

Numerous applications of ceramic aerogels (e.g., alumina aerogels) are possible, including lightweight, thermally-insulating, and sound-insulating materials (e.g., for construction, appliances, electrical applications, battery pack or battery module applications, automotive, and aerospace applications), dielectrics, sensors, catalysts, fuel storage media, filters, low-refractive- index media, mechanical energy absorbers, capacitors, and many others. When filled with matrix materials, such as polymers, metals, or various glasses, ceramic aerogels may allow efficient formation of matrix composites with superior (for a given application) thermal, mechanical, electrical, and/or optical properties. The fabrication of alumina (Al₂O₃) and other Al-comprising aerogels offers great opportunities for the manufacturing of polymer matrix composites with unique, otherwise unattainable properties. However, conventional methods of making alumina (Al₂O₃) aerogels are of high cost and are complex. According to some embodiments, Al₂O₃ nanowires (NW)-based aerogels may be fabricated by simple and low-cost processes that include de-alloying in water at ambient temperatures.

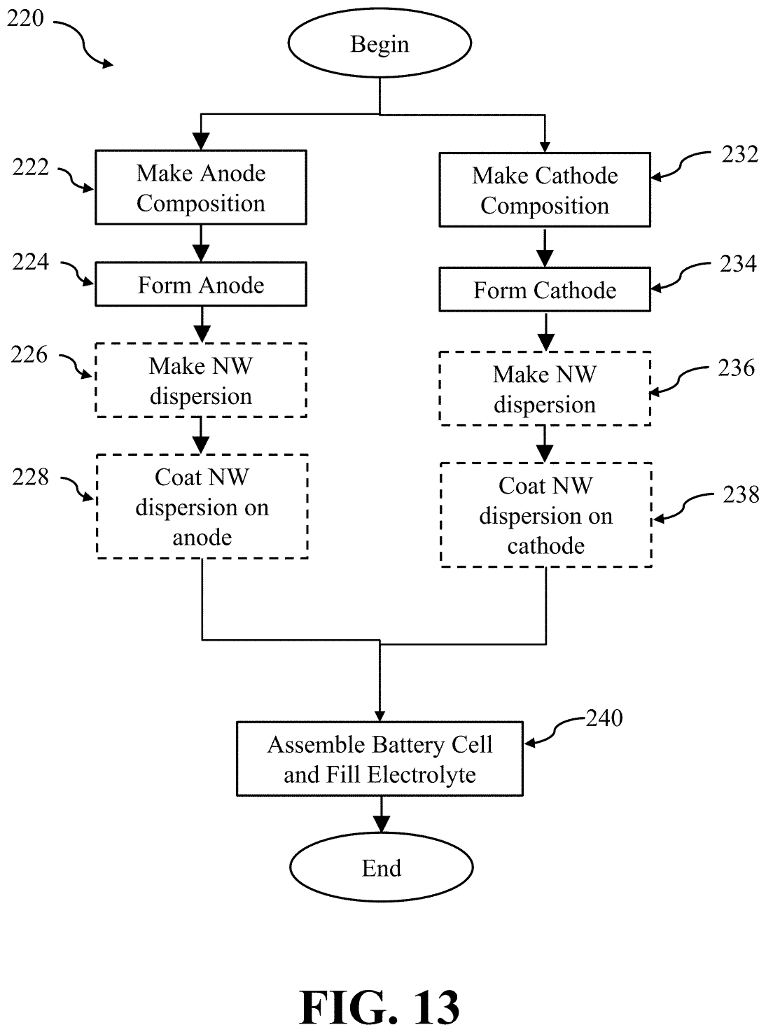

FIG. 13 is a flow diagram of a process 220 of making a lithium-ion battery according to some embodiments in which a nanowire dispersion is coated on at least one of the anode and the cathode. In the example shown, process 220 includes operations 222, 224, 226, 228, 232, 234, 236, 238, and 240. The flow diagram includes an anode branch (left branch) that includes operations 222, 224, 226, and 228, and a cathode branch (right branch) that includes operation 232, 234, 236, and 238. At operation 222, anode particles (e.g., conventional anode particles or core-shell anode particles or composite anode particles, including but not limited to Si-comprising composite particles whereby Si-comprising active material is deposited within pore(s) of a particle core) are made, and at operation 224, an anode is formed. For example, the anode may be formed on and/or in an anode current collector. For example, operation 224 may include: (1) making a slurry comprising anode particles, binders, additives, and solvent(s); and (2) coating the slurry on or in the anode current collector. Similarly, at operation 232, cathode particles (e.g., conventional cathode particles or core-shell cathode particles or composite cathode particles, including but not limited to conversion-type cathode material—comprising composite particles whereby conversion-type cathode material active material is deposited within pore(s) of a particle core) are made, and at operation 234, a cathode is formed. For example, the cathode may be formed on and/or in a cathode current collector. For example, operation 234 may include: (1) making a slurry comprising cathode particles, binders, additives, and solvent(s); and (2) coating the slurry on or in the cathode current collector. Operations 222 and 224, when carried out in a sequence, constitute an example of providing an anode. Operations 232 and 234, when carried out in a sequence, constitute an example of providing a cathode.

Nanowire dispersions (e.g., dispersion of Al hydroxide or oxyhydroxide nanowires made according to process 160 as shown in FIG. 11) may be coated onto electrodes (anodes and/or cathodes). Depending on the implementation, (1) a nanowire dispersion may be coated on the anode to form a separator layer (on the anode), or (2) a nanowire dispersion may be coated on the cathode to form a separator layer (on the cathode), or (3) a respective nanowire dispersion may be coated on the anode and the cathode to form a respective separator layer. To coat a nanowire separator layer on the anode, operations 226 and 228 may be carried out. To coat a nanowire separator layer on the cathode, operations 236 and 238 may be carried out. To coat a respective nanowire separator layer on the anode and the cathode, operations 226, 228, 236, and 238 may be carried out. Operations 226, 236 include making a nanowire dispersion (e.g., dispersion of Al hydroxide nanowires according to process 160, or in other cases, dispersion of Al alkoxide nanowires or dispersion of Al oxide (e.g., Al₂O₃) nanowires). Operation 228 includes coating the nanowire dispersion (e.g., from operation 226) onto the anode. Operation 238 includes coating the nanowire dispersion (e.g., from operation 236) onto the cathode. Subsequently, operation 240 is carried out. Operation 240 includes assembling a lithium-ion battery cell from the anode and the cathode with the at least one separator layer positioned between the anode and the cathode. Additionally, operation 240 may include filling an electrolyte ionically coupling the anode and the cathode in the lithium-ion battery cell to form the lithium-ion battery. Additionally, operation 240 may include carrying out formation cycling on the lithium-ion battery.

In some implementations, an advantage of coating a respective nanowire separator layer on the anode and the cathode may be that a probability of an electrical short between the anode and the cathode is decreased compared to cases in which a nanowire separator layer is formed on either the anode or the cathode. In some implementations, an advantage of coating a nanowire separator layer on either the anode or the cathode (but not both) may be that the total separator thickness is reduced. In some implementations, an advantage of coating a nanowire separator layer on either the anode or the cathode (but not both) may be that the total amount of nanowire material used is reduced. Additionally, in some implementations, process compatibility considerations may play a role. For example, suppose that (1) the anode slurry comprises an aqueous solvent, (2) the cathode slurry comprises an organic, non-aqueous solvent, and (3) the nanowire dispersion comprises an aqueous solvent. In this example, it may be preferable to coat the nanowire dispersion on the cathode only, because if the nanowire dispersion were coated on the anode, the aqueous solvent of the nanowire dispersion may dissolve the binder and other components of the anode.

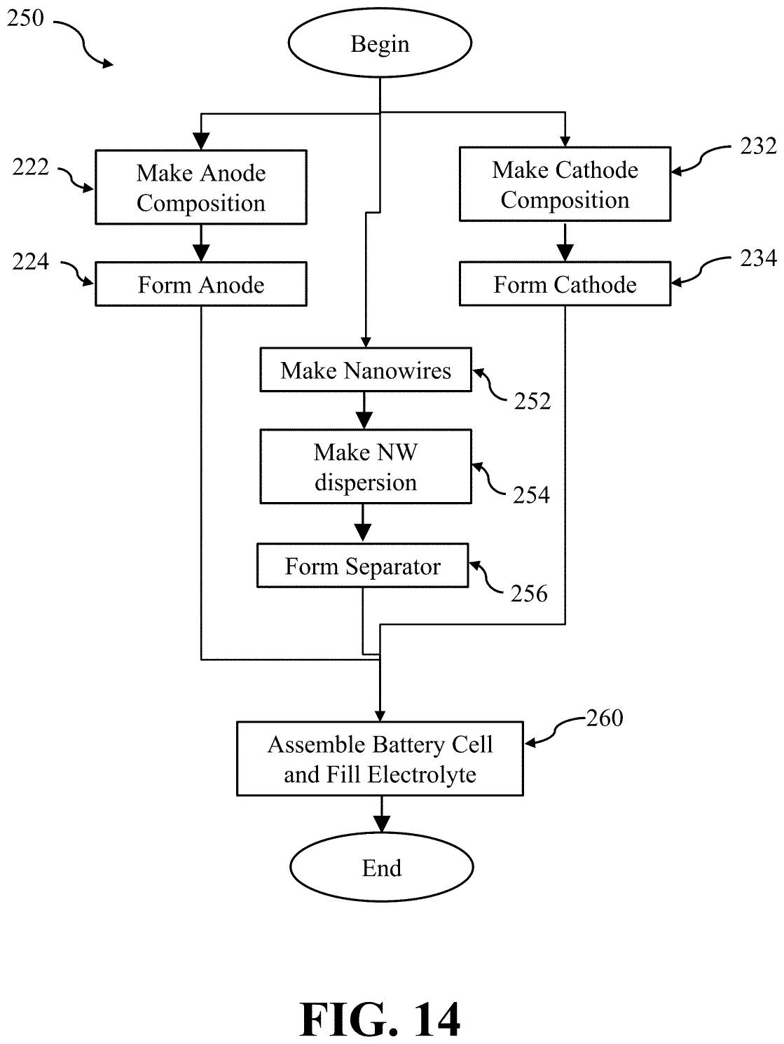

FIG. 14 is a flow diagram of a process 250 of making a lithium-ion battery according to some embodiments in which a nanowire dispersion is employed to form a separator membrane. In the example shown, process 250 includes operations 222, 224, 232, 234, 252, 254, 256, and 260. The flow diagram includes an anode branch (left branch) that includes operations 222 and 224, a cathode branch (right branch) that includes operation 232 and 234, and a separator membrane branch (middle branch) that includes operations 252, 254, and 256. The anode and cathode branch operations have been described with reference to process 220 of FIG. 13. Operation 252 includes making nanowires (e.g., making Al alkoxide nanowires according to process 120 of FIG. 7, making Al oxide nanowires according to process 130 of FIG. 8, making Al hydroxide nanowires according to process 140 of FIG. 9, making Al oxide nanowires according to process 150 of FIG. 10). Operation 254 includes making a dispersion of nanowires (e.g., nanowires from operation 252) by dispersing the nanowires in a solvent. Operation 256 includes forming a separator membrane using a nanowire dispersion (e.g., nanowire dispersion from operation 254). In some implementations, a separator membrane may be formed by coating the nanowire dispersion on a temporary substrate, i.e., a substrate that is removed from the separator membrane before the latter is placed between the anode and the cathode as part of a battery assembly process. In some implementations, a separator membrane may be formed by coating the nanowire dispersion on or in a permanent substrate, i.e., a substrate that remains as part of the separator membrane. For example, the permanent substrate may be a porous substrate. Operation 260 includes assembling a lithium-ion battery cell from the anode, the cathode, and the separator membrane, with the separator membrane positioned between the anode and the cathode. Additionally, operation 260 may include filling an electrolyte ionically coupling the anode and the cathode in the lithium-ion battery cell to form the lithium-ion battery. Additionally, operation 260 may include carrying out formation cycling on the lithium-ion battery.

### Experimental Section

Materials: Lithium foil (battery grade, 0.75 mm, Sigma-Aldrich), aluminum slug (6.35 mm diameter×6.35 mm length, 99.99% (metals basis), Thermo Scientific), ethyl alcohol (pure, 200 proof, anhydrous, >99.5%, Sigma-Aldrich), DI water, Bisphenol F Epoxy Resins (EPON™ 862), hexahydro-4-methylphthalic anhydride (HMPA) hardener (Lindau Chemicals Inc.), 1-cyanoethyl-2-ethyl-4-methylimidazoles (Sigma-Aldrich).

Synthesis of Al—Li Alloy: Approximately 96 wt. % Al and 4 wt. % Li (˜0.5 g in total) was placed in a graphite crucible and rapidly heated to 750° C. (heating rate ˜300° C./min) by an induction heater. Once temperature reached 750° C., the heating was removed, and the samples were allowed to cool in Ar (cooling rate of ˜150° C./min). Temperature was monitored by an optical pyrometer (Calex PyroUSB 2.2, USA).

Synthesis of porous Al: The Al—Li alloy pellet was immersed in 40 mL of DI water for 24 h without stirring/ agitation under Ar flow in a Schlenk line. After initial delithiation, the pellet transformed into a monolithic porous Al along with formation of soluble Li hydroxides. Then, the porous Al sample was washed with an extra 30 mL of DI water three times to remove soluble Li hydroxides. Subsequently, the metallic porous Al bulk was dried under vacuum using a Schlenk line for 24 h.

Synthesis of Al ethoxide NWs: The metallic porous Al bulk was immersed into 40 mL of anhydrous ethyl alcohol for the designated time (˜96 h for full reaction) without stirring/agitation. After the reaction, Al ethoxide NWs anhydrous ethanol slurry formed under argon protection.

Hydrolysis of Al ethoxide NWs: The produced Al ethoxide NWs (WE-NWs) were dried under argon protection for 24 h from their anhydrous ethanol slurry. Then the dry Al-ethoxide NWs were transferred to air atmosphere and kept in air for at least 5 h to finish hydrolysis.

Synthesis of Al oxide NWs aerogel: Approximately 0.2 g air-exposed NWs were re-dispersed in 5 mL DI water with vortex (GENIE® SI-0236 Vortex-Genie 2 Mixer, 120V) and frozen to solid at temperature −4° C. in refrigerator for 12 h. Then the NWs solid was transferred to the lyophilizer (Labconco) and left under vacuum for 24 h. After drying, the NWs aerogel formed and was available for calcination to produce Al oxide NWs aerogel. The amorphous Al₂O₃ NWs aerogel and γ-Al₂O₃ NWs aerogel was annealed in air at 500° C. and 900° C. for 1 h with heating rate as 2° C. min⁻¹, separately.

Characterization: Scanning electron microscopy (SEM) images were obtained using a Hitachi SU8230 SEM instrument. Powder X-ray measurements were performed by using a Panalytical Empyrean XRD system with Cu Kα radiation to identify the crystalline phase of the composite. Thermogravimetric analysis (TGA) was conducted on a TGA Q600 analyzer (TA Instruments) under air atmosphere at a heating rate of 5° C. min-1. Solid-state 2D 3QMAS²⁷A1 NMR was recorded at 25° C. with spinning 12 kHz on a 400 MHz Bruker Avance III spectrometer. ¹³C spectra were acquired at 25° C. with spinning 12 kHz on a 400 MHz Bruker Avance III spectrometer. FTIR was conducted with a Thermo Scientific Nicolet 6700 (USA) with an optical velocity of 0.6329 and resolution of 4 cm⁻¹. Sixty-four scans were collected to average for both sample and background signals. FTIR samples were prepared and analyzed under air.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Clause 1. A method of making aluminum alkoxide nanowires, the method comprising: treating an alloy comprising aluminum (Al) and lithium (Li) with a reactive solvent to form a porous metal comprising Al; and treating the porous metal with an alcohol-comprising solvent to form the Al alkoxide nanowires, wherein: the reactive solvent has a pKa value at 25° C. that is less than 15.

Clause 2. The method of clause 1, wherein: the pKa value at 25° C. is about 14.

Clause 3. The method of any of clauses 1 to 2, wherein: the reactive solvent comprises water.

Clause 4. The method of any of clauses 1 to 3, wherein: the alcohol-comprising solvent comprises ethanol; and the Al alkoxide nanowires comprises Al ethoxide nanowires.

Clause 5. The method of any of clauses 1 to 4, wherein: the alloy comprises Li at a mass fraction in the alloy in a range of about 0.1 wt. % to about 10 wt. %.

Clause 6. The Al alkoxide nanowires made in accordance with the method of any of clauses 1 to 5.

Clause 7. The method of any of clauses 1 to 6, further comprising: annealing the Al alkoxide nanowires to form Al oxide nanowires.

Clause 8. The Al oxide nanowires made in accordance with the method of clause 7.

Clause 9. The method of any of clauses 1 to 8, further comprising: hydrolyzing the Al alkoxide nanowires in a hydrolyzing environment to form Al hydroxide nanowires.

Clause 10. The method of clause 9, wherein: the hydrolyzing environment comprises ambient air.

Clause 11. The Al hydroxide nanowires made in accordance with the method of any of clauses 9 to 10.

Clause 12. The method of any of clauses 9 to 11, further comprising: annealing the Al hydroxide nanowires to form Al oxide nanowires.

Clause 13. The Al oxide nanowires made in accordance with the method of clause 12.

Clause 14. The method of any of clauses 9 to 13, further comprising: dispersing the Al hydroxide nanowires in an aqueous solvent to form a nanowire dispersion.

Clause 15. The method of clause 14, wherein: the aqueous solvent is water.

Clause 16. The nanowire dispersion made in accordance with the method of any of clauses 14 to 15.

Clause 17. The method of any of clauses 14 to 16, further comprising: freeze-drying the nanowire dispersion to form an aerogel, wherein: the aerogel comprises the Al hydroxide nanowires and/or Al oxide nanowires.

Clause 18. The method of clause 17, further comprising: annealing the aerogel.

Clause 19. The method of any of clauses 17 to 18, further comprising: filling the aerogel with a matrix material, the matrix material being selected from polymers, metals, and glasses.

Clause 20. The aerogel made in accordance with the method of any of clauses 17 to 19.

Clause 21. The method of any of clauses 14 to 20, further comprising: coating the nanowire dispersion on at least one of an anode and a cathode to form at least one separator layer; assembling a lithium-ion battery cell from the anode and the cathode with the at least one separator layer positioned between the anode and the cathode; and filling an electrolyte ionically coupling the anode and the cathode in the lithium-ion battery cell to form a lithium-ion battery.

Clause 22. The lithium-ion battery made in accordance with the method of clause 21.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A method of making aluminum alkoxide nanowires, the method comprising:
treating an alloy comprising aluminum (Al) and lithium (Li) with a reactive solvent to form a porous metal comprising Al; and
treating the porous metal with an alcohol-comprising solvent to form the Al alkoxide nanowires,
wherein:
the reactive solvent has a pKₐ value at 25° C. that is less than 15.

2. The method of claim 1, wherein:
the pKₐ value at 25° C. is about 14.

3. The method of claim 1, wherein:
the reactive solvent comprises water.

4. The method of claim 1, wherein:
the alcohol-comprising solvent comprises ethanol; and
the Al alkoxide nanowires comprises Al ethoxide nanowires.

5. The method of claim 1, wherein:
the alloy comprises Li at a mass fraction in the alloy in a range of about 0.1 wt. % to about 10 wt. %.

6. The Al alkoxide nanowires made in accordance with the method of claim 1.

7. The method of claim 1, further comprising:
annealing the Al alkoxide nanowires to form Al oxide nanowires.

8. The Al oxide nanowires made in accordance with the method of claim 7.

9. The method of claim 1, further comprising:
hydrolyzing the Al alkoxide nanowires in a hydrolyzing environment to form Al hydroxide nanowires.

10. The method of claim 9, wherein:
the hydrolyzing environment comprises ambient air.

11. The Al hydroxide nanowires made in accordance with the method of claim 9.

12. The method of claim 9, further comprising:
annealing the Al hydroxide nanowires to form Al oxide nanowires.

13. The Al oxide nanowires made in accordance with the method of claim 12.

14. The method of claim 9, further comprising:
dispersing the Al hydroxide nanowires in an aqueous solvent to form a nanowire dispersion.

15. The method of claim 14, wherein:
the aqueous solvent is water.

16. The nanowire dispersion made in accordance with the method of claim 14.

17. The method of claim 14, further comprising:
freeze-drying the nanowire dispersion to form an aerogel,
wherein:
the aerogel comprises the Al hydroxide nanowires and/or Al oxide nanowires.

18. The method of claim 17, further comprising:
annealing the aerogel.

19. The method of claim 17, further comprising:
filling the aerogel with a matrix material, the matrix material being selected from polymers, metals, and glasses.

20. The aerogel made in accordance with the method of claim 17.

21. The method of claim 14, further comprising:
coating the nanowire dispersion on at least one of an anode and a cathode to form at least one separator layer;
assembling a lithium-ion battery cell from the anode and the cathode with the at least one separator layer positioned between the anode and the cathode; and
filling an electrolyte ionically coupling the anode and the cathode in the lithium-ion battery cell to form a lithium-ion battery.

22. The lithium-ion battery made in accordance with the method of claim 21.
